(19) United States
(12) Patent Application Publication
(10) Pub. No.: US 2025/0230072 A1
(43) Pub. Date: Jul. 17, 2025

(54) SYSTEMS AND METHODS FOR DEGRADING PFAS

(71) Applicant: University of Rochester, Rochester, NY (US)

(72) Inventors: Astrid M. Mueller, Ontario, NY (US); Madeleine K. WILSEY, Rochester, NY (US)

(73) Assignee: University of Rochester, Rochester, NY (US)

(21) Appl. No.: 18/853,710

(22) PCT Filed: Apr. 3, 2023
(86) PCT No.: PCT/US2023/017345

§ 371 Date: Oct. 2, 2024

Related U.S. Application Data
(60) Provisional application No. 63/326,901, filed on Apr. 3, 2022.

(51) Int. Cl. C02F 1/467; C02F 1/32; C02F 1/461; C02F 1/52; C02F 101/36

(52) U.S. Cl. CPC C02F 1/4672; C02F 1/325; C02F 1/46109; C02F 1/5245; C02F 2001/46142; C02F 2101/36; C02F 2305/10

(57) ABSTRACT

The invention provides systems and methods for degrading compounds containing at least one carbon-halogen, carbon-nitrogen, or carbon-oxygen covalent bond, which covalent bond is a single bond, by electrocatalysis using a water oxidation electrocatalyst in a predominantly aqueous electrolyte. In some embodiments, the compounds are perfluoroalkyl and polyfluoroalkyl substances, or “PFAS.”

### CROSS-REFERENCE TO RELATED APPLICATIONS

This application claims priority to, and the benefit of, U.S. Provisional Patent Application No. 63/326,901, filed Apr. 3, 2022, the contents of which are incorporated herein by reference in their entirety.

### STATEMENT OF FEDERAL FUNDING

Not applicable.

### PARTIES TO JOINT RESEARCH AGREEMENT

Not applicable.

### BACKGROUND OF THE INVENTION

Perfluoroalkyl and polyfluoroalkyl substances, commonly referred to as “PFAS,” are a large group of synthetic, industrial chemicals. They are widely used in consumer, commercial, and industrial products because of their exceptional stability and nonstick, stain-repellent, and waterproof properties. They are also an important component of firefighting foams used in, for example, airport and military applications. PFAS are formed of chains of carbons bonded to fluorine atons. As this chemical bond is one of the strongest known, such compounds are extremely resistant to degradation. As stated on the website of the National Institute of Environmental Health Sciences (“NIEHS”), a component of the National Institutes of Health: “these chemicals do not degrade in the environment. In fact, scientists are unable to estimate an environmental half-life for PFAS, which is the amount of time it takes 50% of the chemical to disappear.” See, https://www.niehs.nih.gov/health/topics/agents/pfc/index.cfm. For this reason, PFAS are sometimes called “forever chemicals.”

PFAS have been detected in air, surface waters, and soils and have been in humans and wildlife worldwide. In animal models, various PFAS were found to exhibit hepatotoxicity, developmental toxicity, and immunotoxicity. See, e.g., Lau, et al., Toxicol Sci. 2007 October; 99 (2): 366-94. doi: 10.1093/toxsci/kfm128. A study of serum samples from a representative sample of the American population found PFAS to be present in more than 95% of participants. See, Kato, et al., Environ Sci Technol. 2011 Oct. 1; 45 (19): 8037-45. doi: 10.1021/es1043613. According to the website of the Agency for Toxic Substances and Disease Registry, a part of the U.S. Department of Health and Human Services, the two leading PFAS most Americans have in their blood are perfluorooctane sulfonic acid (“PFOS”) and perfluorooctanoic acid (“PFOA”). See, www.atsdr.cdc.gov/pfas/health-effects/us-population.html. PFOS and PFOA contamination of municipal drinking water in Minnesota required installation of a filtration system to reduce the levels of PFOS and PFOA in the drinking water below the current EPA health advisory level of 70 parts per trillion. Id.

The U.S. government recently launched a plan to combat PFAS pollution because effective PFAS remediation is urgently needed. New technologies are required for the destruction of PFAS without the generation of hazardous byproducts.

Current PFAS remediation efforts are mainly focused on containment at the source of use. But that does not solve issues with PFAS that are already in the environment. Emerging efforts of destructive PFAS removal have been unsuccessful to date, because of high cost, high energy requirements, low efficacy, and toxic byproducts.

PFOA is one of the most widely used and studied chemicals in the PFAS group. Although PFOA use is being phased out in the U.S. (fortunately reflected in declining blood serum levels), it still exists in the environment because of formation from fluorotelomer-based polymers and its persistence. Mineralization of PFOA by γ-irradiation has been reported, but γ-radiation hazards and large capital expense make this method impractical. PFAS destruction by supercritical water oxidation is energy- and cost-intensive. Electro-chemical degradation of PFOA on expensive ultra-nanocrystalline boron-doped diamond coated on niobium electrodes produced toxic perchlorate. See, Schaefer, et al., Chem. Eng. J. 2017, 317:424-432.

It would be desirable to have additional options for degrading PFAS compounds. It would further be desirable to have additional methods and systems for degrading PFAS such as PFOA in the environment, such as by reducing the amount of PFAS in surface waters and groundwater. It would further be desirable to have additional means to reduce the levels of PFAS introduced into the environment around airports, industrial sites, and military installations by industrial processes and firefighting foams. It would further be desirable to have systems and methods that degrade PFAS that also degrade other compounds that are hard to degrade at least in part because of carbon atoms covalently bonded to halogen atoms, nitrogen atoms, or oxygen atoms. Surprisingly, the present invention fulfills these and other needs.

### BRIEF SUMMARY OF INVENTION

In a first group of embodiments, the invention provides systems for degrading a compound containing atoms covalently bonded by a bond between a carbon atom and a halogen atom, a carbon atom and a nitrogen atom, or a carbon atom and an oxygen atom, said system comprising: (a) a first container, (b) an electrolyte solution comprising 46 vol % or more aqueous solution disposed in said first container, which electrolyte solution has a ion concentration allowing ionic conductivity through said electrolyte solution, thereby allowing said electrolyte solution to serve as an electrolyte, (c) one or more compounds containing at least one covalent bond between a carbon atom and a halogen atom, a carbon atom and a nitrogen atom, or a carbon atom and an oxygen atom, which covalent bond is a single bond, said one or more compounds dissolved in said electrolyte solution, (d) a working electrode at least partially immersed in said electrolyte solution, (e) a water oxidation electrocatalyst immobilized on said working electrode and in contact with (1) said one or more compounds dissolved in said electrolyte solution and containing at least one covalent bond between a carbon atom and a halogen atom, a carbon atom and a nitrogen atom, or a carbon atom and an oxygen atom containing a carbon-halogen, carbon-nitrogen, or carbon-oxygen bond, and (2) said electrolyte solution, (f) a counter electrode at least partially immersed in said electrolyte aqueous solution and electrically connected to said working electrode, and, (g) a source of electricity electrically connected to said system to provide an applied electric potential to said working electrode, wherein, when an applied electric potential is applied to said working electrode, said applied electric potential causes said at least one covalent bond between a carbon atom and a halogen atom, a carbon atom and a nitrogen atom, or a carbon atom and an oxygen atom bond between said carbon atom and said halogen atom, said carbon atom and said nitrogen atom, or said carbon atom and said oxygen atom, which covalent bond is a single bond, in said one or more compounds to be broken, thereby degrading said one or more compounds. In some embodiments, the applied electric potential of element (g) is an anodic bias. In some embodiments, the applied electric potential of element (g) is a cathodic bias. In some embodiments, the applied electric potential is −5 V to 5 V versus standard hydrogen electrode (“SHE”), provided that said applied electric potential is not an open circuit potential of said system. In some embodiments, the applied electric potential is an anodic bias and is 0.5 V to 2 V versus SHE. In some embodiments, the applied electric potential is an anodic bias and is 1.0 V to 2 V versus SHE. In some embodiments, the applied electric potential is a cathodic bias and is −5 V to −0.5 V versus SHE. In some embodiments, the applied electric potential is a cathodic bias and is −2 V to −1.0 V versus SHE. In some embodiments, the electrolyte solution is 47 vol %, 48 vol %, 49 vol %, 50 vol % or more water. In some embodiments, the electrolyte solution is 60 vol % or more water. In some embodiments, the electrolyte solution is 70 vol % or more water. In some embodiments, the electrolyte solution is 80 vol % or more water. In some embodiments, the electrolyte solution is 90 vol % or more water. In some embodiments, the working electrode is carbon fiber paper. In some embodiments, the water oxidation electrocatalyst is a metal oxide, metal hydroxide, or metal oxy(hydroxide). In some embodiments, the water oxidation electrocatalyst is a nanostructured layered double hydroxide solid, nanostructured layered oxide solid, nanostructured layered oxy(hydroxide) solid, a perovskite, a polyoxometalate, or a metal-organic framework. In some embodiments, the water oxidation electrocatalyst is a nanostructured layered double hydroxide, oxide solid, or oxy(hydroxide) solid which contains an effective amount of one or more transition metals, a post-transition metal, or both a transition metal and a post-transition metal. In some embodiments, the one or more transition metals are first-row transition metals. In some embodiments, the one or more first-row transition metals are nickel and manganese or nickel and iron. In some embodiments, the post-transition metal is selected from the group consisting of bismuth, gallium, indium, tin, thallium, and lead. In some embodiments, the nanostructured layered double hydroxide, oxide solid, or oxy(hydroxide) solid comprises nickel mixed with an effective amount of a transition metal, a post-transition metal, or both a transition metal and a post-transition metal. In some embodiments, the nanostructured layered double hydroxide, oxide, or oxy(hydroxide) solid is comprised of a mix of nickel with an effective amount of a transition metal, a post-transition metal, or both a transition metal and a post-transition metal is three parts nickel to one part of said transition metal, of said post-transition metal, or of both a transition metal and a post-transition metal. In some embodiments, the post-transition metal is selected from the group consisting of bismuth, gallium, indium, tin, thallium, and lead. In some embodiments, the nanostructured layered double hydroxide, oxide, or oxy(hydroxide) solid is in the form of nanoparticles disposed on the working electrode. In some embodiments, the water oxidation electrocatalyst is [NiMn]-layered double hydroxide, oxide, or oxy(hydroxide). In some embodiments, the [NiMn]-layered double hydroxide, oxide, or oxy(hydroxide) is in the form of nanoparticles disposed on said working electrode. In some embodiments, the water oxidation electrocatalyst is [NiFe]-layered double hydroxide, oxide, or oxy(hydroxide). In some embodiments, the [NiFe]-layered double hydroxide, oxide, or oxy(hydroxide) is in the form of nanoparticles disposed on said working electrode. In some embodiments, the system further comprises (i) a source of ultraviolet light, which source of ultraviolet light is positioned to shine on the water oxidation electrocatalyst. In some embodiments, the first container is fluidly connected to a second container through a first connection. In some embodiments, the system contains a valve disposed between said first container and said first connection fluidly connecting said first container to said second container. In some embodiments, the first container is fluidly connected to a second container through a first connection and said second container is further connected to said first container through a second connection. In some embodiments, the first connection fluidly connecting said first container to said second container is a first hose or a first tube and said second connection from said second container to said first container is a second hose or a second tube. In some embodiments, the second connection fluidly connecting said second container to said first container has a valve disposed between said second container and said second connection. In some embodiments, the source of electricity is a battery. In some embodiments, the system further comprises (h) a reference electrode at least partially immersed in said predominantly aqueous solution and electrically connected to said working electrode and said counter electrode. In some embodiments, the reference electrode is a standard hydrogen electrode. In some embodiments, the reference electrode is Ag/AgCl. In some embodiments, at least one of said one or more compounds contains a covalent bond between a carbon atom and a halogen atom. In some embodiments, the one of said compounds containing at least one covalent bond between a carbon atom and a halogen atom, a carbon atom and a nitrogen atom, or a carbon atom and an oxygen atom compound contains a carbon-fluorine bond. In some embodiments, the compound that contains a carbon-fluorine bond is a per- or polyfluoroalkyl substance (“PFAS”). In some embodiments, the PFAS is a perfluoroalkyl acid. In some embodiments, the PFAS is a perfluoroalkyl carboxylic acid. In some embodiments, the PFAS is perfluorooctanoic acid. In some embodiments, the PFAS is perfluorooctanesulfonic acid. In some embodiments, the at least one of said compounds containing at least one covalent bond between a carbon atom and a halogen atom, a carbon atom and a nitrogen atom, or a carbon atom and an oxygen atom containing a carbon-halogen bond contains a carbon-chlorine bond. In some embodiments, the compound containing a carbon-chlorine bond is a polychlorinated biphenyl (“PCB”). In some embodiments, the at least one of said compounds containing at least one covalent bond between a carbon atom and a halogen atom, a carbon atom and a nitrogen atom, or a carbon atom and an oxygen atom compound is a pesticide. In some embodiments, the at least one of said compounds containing at least one covalent bond between a carbon atom and a halogen atom, a carbon atom and a nitrogen atom, or a carbon atom and an oxygen atom is a dioxin. In some embodiments, the at least one of said compounds containing at least one covalent bond between a carbon atom and a halogen atom, a carbon atom and a nitrogen atom, or a carbon atom and an oxygen atom compound is a volatile organic compound. In some embodiments, the system further comprises a heater to heat said electrolyte solution above room temperature. In some embodiments, the system further comprises a source introducing air or oxygen into said electrolyte solution. In some embodiments, the electrolyte solution further comprises 54 vol % or less non-aqueous solvent. In some embodiments, the electrolyte solution is 60 vol % or more water and 40 vol % or less non-aqueous solvent. In some embodiments, the electrolyte solution is 90 vol % or more aqueous solution and 10 vol % or less non-aqueous solvent. In some embodiments, the non-aqueous solvent is ethanol, methanol, 1-propanol, butanol, or acetonitrile.

In another group of embodiments, the invention provides methods for degrading a compound containing at least one covalent carbon-halogen, carbon-nitrogen, or carbon-oxygen bond, said covalent bond being a single bond, said method comprising subjecting said compound containing said carbon-halogen, said carbon-nitrogen, or said carbon-oxygen bond to electrocatalysis on a water oxidation electrocatalyst, said water oxidation electrocatalyst being disposed on a working electrode, said electrode being disposed in an electrolyte solution comprising 46 vol % or more of water and having an ion concentration allowing ionic conductivity, by providing an applied electric potential of −5 V to 5 V versus standard hydrogen electrode (“SHE”) to said working electrode, thereby breaking said carbon-halogen, carbon-nitrogen, or carbon-oxygen bond in said compound containing a carbon-halogen, carbon-nitrogen, or carbon-oxygen bond, thereby degrading said compound, provided said applied electric potential is not an open circuit potential. In some embodiments, the electrolyte solution is 46%, 47%, 48%, 49% or 50 vol % or more water. In some embodiments, the electrolyte solution is 60 vol % or more water. In some embodiments, the electrolyte solution is 70 vol % or more water. In some embodiments, the electrolyte solution is 80 vol % or more water. In some embodiments, the electrolyte solution is 90 vol % or more water. In some embodiments, the electrolyte solution further comprises a non-aqueous solvent. In some embodiments, the non-aqueous solvent contains a concentration of ions sufficient to provide ion conductivity. In some embodiments, the In some embodiments, the working electrode is hydrophilic carbon fiber paper. In some embodiments, the water oxidation electrocatalyst is a metal oxide solid, metal hydroxide solid, or metal oxy(hydroxide). In some embodiments, the water oxidation electrocatalyst is a nanostructured layered double hydroxide solid, nanostructured layered oxide solid, nanostructured layered oxy(hydroxide) solid, a perovskite, a polyoxometalate, or a metal-organic framework. In some embodiments, the water oxidation electrocatalyst is a nanostructured layered double hydroxide solid, nanostructured layered oxide solid, nanostructured layered oxy(hydroxide) solid, a perovskite, a polyoxometalate, or a metal-organic framework is in the form of nanoparticles disposed on the working electrode. In some embodiments, the water oxidation electrocatalyst is a nanostructured layered double hydroxide solid, nanostructured layered oxide solid, or nanostructured layered oxy(hydroxide) solid, in which one of the layers comprises an effective amount of a transition metal, a post-transition metal, or both a transition metal and a post-transition metal. In some embodiments, the transition metal is a first-row transition metal. In some embodiments, the first-row transition metal is manganese or iron. In some embodiments, the post-transition metal is selected from the group consisting of bismuth, gallium, indium, tin, thallium, and lead. In some embodiments, the nanostructured layered double hydroxide solid, said nanostructured layered oxide solid, or said nanostructured layered oxy(hydroxide) solid, comprises nickel mixed with an effective amount of a transition metal, a post-transition metal, or both a transition metal and a post-transition metal. In some embodiments, the nanostructured layered double hydroxide solid, said nanostructured layered oxide solid, or said nanostructured layered oxy(hydroxide) solid, comprising nickel mixed with an effective amount of a transition metal, a post-transition metal, or both a transition metal and a post-transition metal, is in the form of nanoparticles disposed on the working electrode. In some embodiments, the nanostructured layered double hydroxide solid, said nanostructured layered oxide solid, or said nanostructured layered oxy(hydroxide) solid comprises nickel mixed with an effective amount of a transition metal. In some embodiments, the water oxidation electrocatalyst is [NiFe]-layered double hydroxide, [NiFe]-nanostructured layered oxide solid, or [NiFe]-nanostructured layered oxy(hydroxide) solid. In some embodiments, the [NiFe]-layered double hydroxide, [NiFe]-nanostructured layered oxide solid, or [NiFe]-nanostructured layered oxy(hydroxide) solid is in the form of nanoparticles disposed on said working electrode. In some embodiments, the water oxidation electrocatalyst is [NiMn]-layered double hydroxide, [NiMn]-nanostructured layered oxide solid, or [NiMn]-nanostructured layered oxy(hydroxide) solid. In some embodiments, the [NiMn]-layered double hydroxide, [NiMn]-nanostructured layered oxide solid, or [NiMn]-nanostructured layered oxy(hydroxide) solid is in the form of nanoparticles disposed on said working electrode. In some embodiments, the applied electric potential is an anodic bias. In some embodiments, the applied electric potential is 0.5 V to 5 V versus standard hydrogen electrode (“SHE”). In some embodiments, the applied electric potential is 1.0 V to 2 V versus standard hydrogen electrode SHE. In some embodiments, the applied electric potential is 1.0 V to 1.75 V versus SHE. In some embodiments, the applied electric potential is a cathodic bias. In some embodiments, the applied electric potential is −0.5 V to −5 V versus standard hydrogen electrode (“SHE”). In some embodiments, the applied electric potential is −1.0 V to −2 V versus standard hydrogen electrode SHE. In some embodiments, the applied electric potential is −1.0 V to −1.75 V versus SHE. In some embodiments, the electrolyte solution is at room temperature. In some embodiments, the electrolyte solution is at a temperature above room temperature. In some embodiments, the electrolyte solution is at a temperature of 30° C. to 99° C. In some embodiments, the electrolyte solution is at a temperature of 70° C. to 99° C. In some embodiments, the electrolyte solution is at a temperature of 90° C. to 99° C. In some embodiments, the method further comprises shining ultraviolet light on said water oxidation electrocatalyst. In some embodiments, the electrocatalysis is conducted for 15 minutes to 24 hours. In some embodiments, the electrocatalysis is conducted for 15 minutes to 16 hours. In some embodiments, the electrocatalysis is conducted for 15 minutes to 12 hours. In some embodiments, the electrocatalysis is conducted for 15 minutes to 8 hours. In some embodiments, the electrocatalysis is conducted for 15 minutes to 4 hours. In some embodiments, the compound containing a carbon-halogen, carbon-nitrogen, or carbon-oxygen bond is a pesticide. In some embodiments, the compound containing a carbon-halogen, carbon-nitrogen, or carbon-oxygen bond is a dioxin. In some embodiments, the compound containing a carbon-halogen, carbon-nitrogen, or carbon-oxygen bond is a volatile organic compound. In some embodiments, the compound containing at least one carbon-halogen, carbon-nitrogen, or carbon-oxygen bond contains a carbon-chlorine bond. In some embodiments, the compound containing a carbon-chlorine bond is a polychlorinated biphenyl (“PCB”). In some embodiments, the compound containing at least one carbon-halogen, carbon-nitrogen, or carbon-oxygen bond contains a carbon-fluorine bond. In some embodiments, the compound containing a carbon-fluorine bond is a per- or polyfluoroalkyl substance (“PFAS”). In some embodiments, the PFAS is a perfluoroalkyl acid. In some embodiments, the PFAS is a perfluoroalkyl carboxylic acid. In some embodiments, the PFAS is perfluorooctanoic acid. In some embodiments, the method further comprises mineralizing said fluorine atoms dissociated from said PFAS by said electrocatalysis, said method comprising adding to said electrolyte cations that form water-insoluble fluorides, thereby mineralizing said fluorine atoms dissociated from said PFAS. In some embodiments, the cations that form water-insoluble fluorides are one or more of magnesium, calcium, strontium, barium, gallium, copper, zinc, lead, zirconium, thorium, vanadium, chromium, and gold cations. In some embodiments, the cations that form water-insoluble fluorides are one or more of magnesium, calcium, copper, zinc, and lead cations. In some embodiments, the cations that form water-insoluble fluorides are calcium cations. In some embodiments, the at least compound containing a carbon-halogen, carbon-nitrogen, or carbon-oxygen bond has a carbon-halogen bond and wherein said electrocatalysis is conducted in a first container and, further wherein, after said compound soluble in water having a carbon-halogen bond has been subjected to said electrocatalysis for a period of time, said electrolyte comprising any halogen atoms released from said compound containing a carbon-halogen bond or a derivative of said halogen atoms is transferred to a second container and contacted in said second container with cations that form water-insoluble compounds with said halogen atoms or derivatives of halogen atoms, thereby mineralizing said halogen atoms or derivatives of halogen atoms dissociated from said PFAS. In some embodiments, the cations that form water-insoluble compounds with halogen atoms or derivatives of halogen atoms are one or more of magnesium, calcium, strontium, barium, gallium, copper, zinc, lead, zirconium, thorium, mercury, vanadium, chromium, and gold cations. In some embodiments, the one or more cations that form water-insoluble compounds with halogen atoms or derivatives of halogen atoms are magnesium, calcium, mercury, copper, zinc, and lead cations. In some embodiments, the one or more cations that form water-insoluble compounds with halogen atoms or derivatives of halogen atoms are calcium cations.

### BRIEF DESCRIPTION OF THE DRAWINGS

FIG. 1. FIG. 1 is a schematic diagram showing an overall flow path for subjecting PFAS in an electrolyte solution to electrocatalysis, followed by mineralization of fluoride anions released from the PFAS by the electrocatalysis.

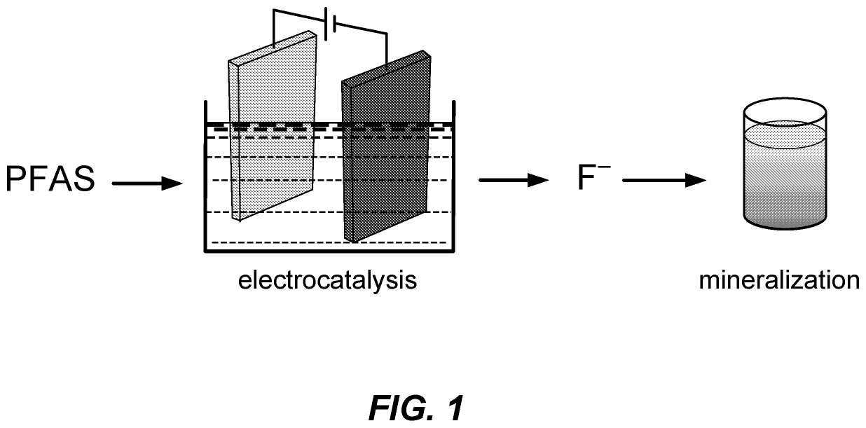

FIG. 2. FIG. 2 presents two graphs presenting X-ray spectroscopy of scanning electron microscopy (“SEM-EDX”) spectra of Ca2+ precipitate after electrolysis of an electrolyte with PFOA (left graph) or one without PFOA (right graph). Detected elements arise from CaF₂, CaCO₃, Ca(OH)₂, CaCl₂, and KOH. Si was likely dissolved from the glassware of the electrocatalysis cell in the pH 13 electrolyte.

FIG. 3. FIG. 3 sets forth illustrations showing three embodiments for conducing degradation of PFAS in a electrolysis cell. The top illustration shows a batch set up for conducting electrocatalysis. The middle illustration depicts a flow embodiment, in which the electrodes are positioned perpendicular to the direction of flow. The bottom illustration depicts a flow embodiment, in which the electrodes are positioned parallel to the direction of flow.

FIG. 4. FIG. 4 is a graph showing the results of a study comparing the electrocatalysis of an exemplar PFAS at 25° C. at three time points to the electrocatalysis of the same PFAS on the same water oxidation electrocatalyst at the same time points under the same conditions, but at 60° C. The effect of the electrocatalysis is measured in the study by the concentration of F⁻ released by the PFAS into the solution, as the PFAS is the only source of F⁻ in the system. The dip in the release of F⁻ at hour 2 is a common feature of electrocatalysis, as the various reactive species generated by the electrocatalytic reaction have different half lives and persistence in the electrolytic solution.

FIG. 5. FIG. 5 is a graph comparing the electrocatalysis of two exemplar PFAS, PFOA and PFOS, over time under the same electrocatalytic conditions. The effect of the electrocatalysis is measured in the study by the concentration of F⁻ released by the respective PFAS into the solution, as each respective PFAS was the only source of F⁻ in the system during its electrocatalysis.

FIG. 6. FIG. 6 is a graph comparing the electrocatalysis of an exemplar PFAS over time under the same electrocatalytic conditions, but under either an anodic bias of 1.6 V_{RHE} or a cathodic bias of −1.6V_{RHE}. The effect of the electrocatalysis is measured in the study by the concentration of F⁻ released by the PFAS into the solution, as the PFAS was the only source of F⁻ in the system.

FIG. 7. FIG. 7 is a graph comparing the electrocatalysis of an exemplar PFAS over time under the same electrocatalytic conditions, but with the water oxidation electrocatalyst supported either by hydrophilic carbon fiber paper (“CFP”) or nickel mesh. The effect of the electrocatalysis is measured in the study by the concentration of F⁻ released by the PFAS into the solution, as the PFAS was the only source of F⁻ in the system.

### DETAILED DESCRIPTION

### Introduction

As set forth in the Background, perfluoroalkyl and polyfluoroalkyl substances, commonly referred to as “PFAS,” are synthetic chemicals that have been shown to have toxicity in animal models. Unfortunately, they are now widely distributed in the environment, and, based on a study of serum samples taken from individuals in a representative sample of the American public, most Americans carry one or more PFAS in their body. See, Kato, et al., supra. See also, Lau, et al., Toxicol Sci., 2007, 99(2):366-94. doi: 10.1093/toxsci/kfm128. Methods of degrading PFAS would be highly desirable. PFAS are, however, extremely stable compounds and current technologies for degrading PFAS have been limited by a combination of high cost, high energy requirements, low efficacy, and the production of toxic byproducts.

Surprisingly, the present invention provides systems and methods that allow PFAS to be degraded to low toxicity compounds at low energy cost, low capital expense, high efficiency, the ability to operate at ambient conditions, and without the need for chemical oxidants. In the systems and methods of the invention, electrocatalysis is used to break down perfluoroalkyls using a metal-based water oxidation catalyst.

Since the covalent bond between the carbon atom and fluorine atoms present in PFAS compounds is one of the strongest single-bonds known, it is expected that the systems and methods taught herein for degrading PFAS compounds can also be used to degrade other molecules that contain a covalent single bond between a carbon atom and a halogen atom other than a fluorine atom, as well as compounds with single bonds weaker than those between a carbon atom and a halogen atom, such as those between a carbon atom and a nitrogen atom, or between a carbon atom and an oxygen atom. For example, it is expected that the systems and methods taught herein for degrading PFAS compounds can also be used to degrade other compounds containing a carbon atom covalently bound to a chlorine atom, a bromine atom, or an iodine atom. In addition to PFAS, it is therefore expected that the systems and methods taught herein will be widely useful in degrading other pollutants present in groundwater or surface waters, the removal of which pollutants has not been possible using the techniques available to date. It is expected that the systems and methods described in this disclosure can be used to degrade pollutants such as dioxins, polychlorinated biphenyls (“PCBs”), pesticides (such as herbicides, insecticides, fungicides, rodenticides, and algicides), volatile organic compounds, plasticizers, and chlorinated solvents. While the systems and methods discussed below are generally described in terms of degrading PFAS compounds by providing them to an electrolyte solution and subjecting them to electrocatalysis, it will be understood that the descriptions can also apply to degrading many other compounds of present in a sample provided to the electrolyte solution and subjected to electrocatalysis.

Surprisingly, and contrary to the previous understanding in the art, the electrocatalysis is conducted with the PFAS compound (or other compound to be degraded) in an electrolyte solution that is 46 vol % or higher water, preferably at least 50 vol % water, and more preferably, higher than 50 vol % water. As discussed further below, for compounds soluble in water, the electrocatalysis can be surprisingly be conducted in almost pure water, as long as enough ions are present or added to allow the water to serve as an electrolyte, and, of course, with PFAS or another compound to be degraded present as the reactant to be dissociated in the course of being subjected to electrocatalysis.

Without wishing to be bound by theory, in embodiments in which the compound to be degraded is a PFAS, the systems and methods allow the destruction of PFAS dissolved in the water by dissociating fluorine atoms bound to carbons in the PFAS, releasing the fluorine atoms into the electrolyte solution. The form in which the fluorines in the starting PFAS are dissociated from the PFAS and released into the electrolyte is sometimes referred to herein as a derivative of the fluorines originally present in the PFAS. Without wishing to be bound by theory, it is believed that the fluorines dissociated from the PFAS are in the electrolyte in the form of fluoride. For convenience of reference, the fluorides (or whatever other form or derivative of the fluorines originally present in the PFAS are present in the electrolyte after the fluorine atom is dissociated from a carbon atom in the PFAS) will sometimes be referred to herein as “fluorine derivatives.” The fluorine derivatives released from PFAS can then precipitated out of solution and sequestered by contacting the fluorine derivative to form non-soluble compounds, as discussed further below. It is expected that compounds having at least one carbon atom covalently singly bonded to a halogen atom other than fluorine, such as PCBs, in which one or more carbon atoms are covalently bound to chlorine atoms, can likewise have their halogen atoms dissociated from the starting compound by electrocatalysis and that the dissociated halogen atoms (or whatever form of the halogen atoms originally present in the compound are present in the electrolyte) can then be precipitated out of solution and sequestered in a form less toxic than the original compound by contacting the halogen atoms with suitable cations to form non-soluble compounds. It is generally expected that environmental pollutants degraded by the systems and methods taught herein will have degradation products that are less toxic than the starting environmental pollutant, that will be less persistent in the environment than the starting environmental pollutant, or both.

The discovery that PFAS can be degraded while present in an aqueous solution is particularly advantageous for the use of systems and methods of the invention in environmental remediation. As mentioned above, PFAS has contaminated groundwater or surface water around manufacturing sites in which PFAS was made or applied to products, and around airports or military facilities in which PFAS-containing firefighting foam have been released. In some embodiments, the inventive methods and systems allow providing PFAS-contaminated water directly to electrocatalysis without elaborate pretreatment (as noted below, however, the water might first be filtered to remove solids and any suspended particles might first be allowed to settle before commencing the electrocatalysis.) Thus, as discussed further below, it is contemplated that in some embodiments, water contaminated with PFAS will be provided directly to a container in which electrocatalysis will be conducted, its ionic strength adjusted if and as necessary to allow the contaminated water to serve as an electrolyte (for example, by adding a base, acid, or salt to provide the ions necessary for current to move through the resulting solution, for contaminated water which does not already have a sufficient concentration of such ions), and then subjecting the PFAS in the resulting electrolytic solution to electrocatalysis using a water oxidation electrocatalyst. Degradation of compounds that are not soluble in water to a significant degree will be discussed in a later section. Hydrocarbons are not among the set of compounds that can be degraded by the inventive systems and methods.

As noted above, the discovery that PFAS can be subjected to electrocatalytic oxidation in an electrolyte solution that is at least 46 vol % aqueous and preferably 50 vol % or higher, is surprising. This is in part because the art has taught that no significant percentage of water can be present when subjecting materials, and particularly hydrocarbon-based materials, to electrocatalytic oxidation. For example, Hunter et al., U.S. Patent Application Publication US 2018/0044804 (hereafter, the “Hunter application,” which is incorporated herein by reference) reports the use of water oxidation catalysts, such as laser-made [NiFe]-layered double hydroxide, to generate an oxidized hydrocarbon product from a hydrocarbon reactant by contacting the water oxidation catalyst with hydrocarbon reactant and water in the presence of a non-aqueous solvent.

The Hunter application abstract states that water is provided in the non-aqueous solvent in a concentration equal to or less than 0.5 vol %. Studies underlying the present disclosure showed that the teachings of the Hunter application are wrong, at least with respect to the degradation of non-hydrocarbon compounds. The inventive methods and systems exploit the discovery that the electrocatalytic degradation of PFAS requires the use of an electrolyte solution with a percentage of water that is higher than 45 vol %. In some embodiments, the percentage of water in said electrolytic solution 46 vol %, 47 vol %, 48 vol %, 49 vol %, 50%, or more, such as 55 vol %, 60 vol %, 65 vol %, 70 vol %, 75 vol %, 80 vol %, 85 vol %, 90 vol %, 95 vol %, 96 vol %, 97 vol %, 98 vol %, 99 vol %, 99.5 vol %, or higher, with a concentration of or above 50 vol % being preferred over any concentration below 50 vol %. In some embodiments, the concentration of water in the electrolyte solutions used in the present invention is 50 vol % or more. In some embodiments, the concentration of water in the electrolyte solutions used in the present invention is 60 vol % or more. In some embodiments, the concentration of water in the electrolyte solutions used in the present invention is 70 vol % or more. In some embodiments, the concentration of water in the electrolyte solutions used in the present invention is 75 vol % or more. While the percentages between 50 vol % and 95 vol % are set forth at 5 vol % intervals for conciseness, the concentrations of water above 50 vol % include any intermediate percentage between 50 vol % and 99.9 vol %, such as 51.25 vol %, 67.33 vol %, or 82.82 vol %.

For convenience of reference, a solution in which the concentration of water is sufficient to allow PFAS or other compound to be degraded in the solution to be subjected to electrocatalysis by a water oxidation electrocatalyst is sometimes referred to herein as a “first aqueous solution.” As the solution in which the concentration of water is sufficient to allow PFAS in the solution to be subjected to electrocatalysis by a water oxidation electrocatalyst will typically be close to at least 50 vol % water, and more typically will be one in which the percentage of water is higher than 50 vol %, such as 60 vol % water, 75 vol % water, 80 vol % water, or higher, the electrolyte solution in which the electrocatalysis is performed is sometimes referred to herein as a “predominantly aqueous solution.”

In many embodiments, water contaminated with PFAS, such as surface water from a lake or creek, or ground water, is already predominantly water and can be introduced directly into the system for performing electrocatalysis. It is expected that, in some of these embodiments, the PFAS-contaminated water to be remediated already contains a sufficient concentration of ions to serve as the electrolyte in an electrocatalysis cell. In other embodiments, the concentration of ions in the contaminated water to be remediated does not itself already contain a high enough concentration of ions to serve as the electrolyte for electrocatalysis. In such cases, an ionic compound, such as a base, an acid, or a salt is added to provide the necessary concentration of ions. For convenience of reference, an electrolyte solution containing a concentration of ions sufficient to serve as the electrolyte for electrocatalysis will usually be referred to herein as the “electrolyte” or the “electrolytic solution,” regardless of whether the contaminated water in the predominantly aqueous solution already contained a high enough concentration of ions for electrocatalysis or if an ionic compound was added to the predominantly aqueous solution to provide an adequate concentration. As noted elsewhere in this disclosure, electrocatalysis has been performed in the art for decades, and persons of skill are well familiar with the threshold concentrations of ions that have to be present in any particular solution for the solution to serve as an electrolyte for electrocatalysis to proceed, as well as how to determine if that concentration of ions is present in a solution the practitioner wishes to use as an electrolyte.

In one aspect, the invention relates to reducing the concentration of one or more PFAS compounds present in a water sample by removing and, preferably, mineralizing at least some of the fluorine atoms present in the PFAS compound or compounds. The reduction of concentration of PFAS is accomplished by a two-step process: (1) the one or more PFAS compounds in the electrolyte are placed in contact with a water oxidation electrocatalyst under an applied electric potential (e.g., an anodic or a cathodic bias) which results in breaking one or more C—F bonds in the one or more PFAS compounds, thereby dissociating fluorine atoms from their C—F bonds and releasing them into the electrolyte as fluorides and, (2) cations are added to the electrolyte to react with the fluorides to form a compound that is insoluble in the electrolyte.

The Hunter application is directed to degrading hydrocarbons by electrocatalysis in a solution of which 95 vol % or more is a non-aqueous solvent (e.g., a solution of which 95 vol % or more is an organic solvent). In contrast, and without wishing to be bound by theory, it is believed that conducting the electrocatalysis of PFAS and other compounds that have a carbon-halogen bond in a solution that is 46 vol % or more water, and preferably 50 vol % or more water, is important to the ability of the inventive systems and methods to break the C—F bonds in the PFAS, thereby releasing the fluorine atoms from the PFAS. As persons of skill will appreciate, the C—F bond in a PFAS compound is considerably stronger than the C—H bonds present in hydrocarbons and breaking a C—F bond requires different conditions than those sufficient to break a C—H bond. In preferred embodiments, the compounds subjected to electrocatalysis by the inventive systems and methods are not hydrocarbons.

Further without wishing to be bound by theory, it is believed in the art that electrocatalysis proceeds in part by the formation of catalytic intermediates. Without wishing to be bound by theory, it is believed that using an electrolyte solution that is 46 vol % or more water, and preferably 50 vol % or more water, enables proton-coupled electron transfer (“PCET”), thereby reducing the energy of the catalytic intermediates and smoothing out the PCET process, sometimes referred to in the art as “potential leveling.” Without wishing to be bound by theory, it is believed that potential leveling does not occur under the electrolytic conditions set forth in the Hunter application and that such conditions do not allow electrocatalytic degradation of a PFAS to occur.

Studies underlying the present disclosure subjecting an exemplar PFAS compound to electrocatalysis in solutions having water present at different concentrations revealed that the exemplar PFAS was not degraded when water was present at 45 vol %, but did occur when water was present at 50 vol %. Thus, electrocatalysis of PFAS should be performed using an electrolyte solution that is at least 46 vol % or more water, and preferably is 47 vol %, 48 vol %, 49 vol %, with each successive larger percentage being preferred to the smaller one to its left. In preferred embodiments, the electrolyte solution is 50 vol % or more water, and preferably has more water than non-aqueous solvent. Any particular electrolyte solution with any particular concentration of water, such as 64.75 vol % water or 73.22 vol % water, with the remainder made up of a non-aqueous solvent, such as ethanol, can be readily tested by simply preparing the solution and subjecting an exemplar PFAS compound or of another compound of interest to electrocatalysis following the teachings herein. If the PFAS or other compound of interest is degraded by the electrolysis (as evidenced, for example, by the release of fluorine atoms or ions from a PFAS, chlorine atoms or ions from a PCB, or the formation of other products showing that the target compound has been degraded), that particular combination of water and non-aqueous solvent is suitable for use in degrading the PFAS or other compound of interest.

In addition to allowing the dissociation of fluorine atoms from PFAS, the high water concentration of the electrolyte solution compared to those previously taught for degradation of compounds provides a number of surprising advantages to the systems and methods of the invention over those previous teachings. As noted, the Hunter application teaches that its electrocatalysis of hydrocarbon reactants (which the application mentions can include halogens as optional substituents for an alkyl, alkenyl, or aryl group within the hydrocarbons it encompasses) is conducted in a non-aqueous solvent, with a very small amount of water present. Assuming that the methods of the Hunter application would work when applied to a PFAS compound, remediation of any substantial amount of water contaminated with PFAS following the teachings of the Hunter application would require the use of large amounts of non-aqueous solvent and the subsequent disposal of the large volumes of the non-aqueous solvent after the non-aqueous solvent has been used in the remediation efforts.

In contrast, the inventive systems and methods do not require predominantly non-aqueous solvents, reducing or removing the need to first provide, and then to dispose of, substantial volumes of non-aqueous solvents. Further, as mentioned above, since the inventive systems and methods use an electrolyte solution that is 46 vol % or more water, and that is preferably at least 50 vol % or more water, PFAS-contaminated surface water or groundwater itself can provide both the reactant (the PFAS) to be decomposed by electrolysis and some or all of the aqueous solution to serve as the electrolyte for the electrocatalytic process. Most of the studies of degrading PFAS reported in the Examples used pure water, with only a salt added to permit the water to serve as an electrolyte. Thus, while the electrolyte solution of the inventive systems and methods can comprise, for example, an equal amount of a non-aqueous solvent, in preferred embodiments, the electrolyte solution is 75 vol %, 80 vol %, 85 vol %, 90 vol %, or a higher percentage water, especially in embodiments in which the water is taken directly from groundwater or surface water that is being remediated. It is contemplated that non-aqueous solvents will be added to the water only if and as necessary to dissolve pollutants, such as PCBs or dioxins, that are not soluble in water, but that the resulting electrolyte solutions will still be predominantly aqueous.

Thus, in some embodiments, the electrolyte solution may be, for example, 99.5 vol % water, compared to comprising on 0.5% of the electrolyte solutions taught by the Hunter application. Even embodiments of the inventive systems and methods that use, for example, electrolyte solutions in which 75 vol %, 80 vol %, 85 vol %, or 90 vol % of the solution is water sharply reduce the amount of non-aqueous solvent that has to be handled or disposed of compared to the electrolyte solutions taught by the Hunter application. For example, each liter of electrolyte prepared according to Hunter will comprise 995 mL of non-aqueous solvent and at most 5 mL of water, while a 99.5 vol % water solution used in some typical embodiments of the present invention will comprise 995 mL of water and 5 mL of non-aqueous solvent, requiring the distilling or discarding only 0.5% organic solvent compared to that of the Hunter electrolyte solution.

As noted above, studies in which pure water was used as the electrolyte required the addition of a salt to provide ions. In some situations, it is anticipated that groundwater or surface water which the practitioner wishes to remediate to reduce the concentration of PFAS, PCBs, dioxins, or other pollutants in it also already contains dissolved ionic compounds in amounts sufficient for the contaminated water to serve as the electrolyte without first having to add a salt to provide ions. In cases in which the contaminated water does not already contain a sufficient quantity of dissolved ionic compounds to serve as an electrolyte, an ionic compound will typically be added to provide the water with a sufficient concentration of ions to allow it to serve as an electrolyte electrically connecting the electrodes of the electrolytic cell. In part for this reason, it is expected that it will not generally be necessary to purify the contaminated water prior to subjecting it to electrolysis.

It is understood that the contaminated water, such as water being drawn from a drainage basin on an industrial site, may contain solids, whether being drawn in with the water or suspended in it. In such cases, the practitioner may choose to filter the solids out of the contaminated water before subjecting the contaminated water to electrocatalysis. In some cases, contaminated water that is milky or that otherwise has particles suspended in it may be provided time for the suspended particles to settle out before the water, now bearing a reduced burden of particles, is subjected to electrocatalysis.

The fact that the PFAS can be subjected to electrocatalysis without needing to be in a purified aqueous environment provides yet a further advantage, as PFAS-contaminated water from surface water or groundwater will typically also contain a variety of naturally-occurring organic compounds, such as those from living or decomposing vegetation and from organisms living in the water, as well as synthetic pesticides that have leached into the water and fertilizer that has run-off farms, lawns, or other land to which it was applied. It is anticipated that, in some embodiments, the PFAS-contaminated water will not have to be purified to remove such compounds before being subjected to electrocatalysis. Not having to remove such naturally-occurring organic compounds before electrocatalysis in these embodiments of the inventive methods and systems is expected to reduce the time and cost for remediating PFAS contamination, and to provide the inventive methods and systems with significant advantages compared to currently-available techniques. The same is expected to be true with respect to using the inventive systems and methods to reduce the concentration of other pollutants (such as the pesticides mentioned above) present in the water.

### Water Oxidation Electrocatalysts

The water oxidation electrocatalysts contemplated for use in the inventive systems and methods are metal-based. In some embodiments, for example, the metal-based water oxidation electrocatalyst may comprise one or more transition metals. In an embodiment, for example, the water oxidation electrocatalyst may comprise Ru. In some embodiments, the water oxidation electrocatalyst is a metal oxide or a metal hydroxide. In some embodiments, the water oxidation electrocatalyst is a metal oxide or metal hydroxide that comprises one or more earth abundant metals. In some embodiments, the water oxidation electrocatalyst is a metal oxide or metal hydroxide that comprises one or more metals selected from the group consisting of Ni, Fe, Co, Mn, Zn, Sc, V, Cr, Cu, Ti, or a lanthanide. In some embodiments, the water oxidation electrocatalyst is a layered solid. In some embodiments, the water oxidation electrocatalyst is a layered solid that is a layered double hydroxide, oxide, or oxy(hydroxide). In some embodiments, the water oxidation electrocatalyst is a layered double hydroxide, oxide, or oxy(hydroxide) solid that comprises a Ni hydroxide, oxide, or oxy(hydroxide), an Fe hydroxide, oxide, or oxy(hydroxide), or a Ni—Fe hydroxide, oxide, or oxy(hydroxide). In some embodiments, the water oxidation electrocatalyst is a layered double hydroxide, oxide, or oxy(hydroxide) solid that is nanostructured. In some embodiments, the water oxidation electrocatalyst is a layered double hydroxide, oxide, or oxy(hydroxide) solid that is generated via pulse laser ablation in liquid. In some embodiments, the water oxidation electrocatalyst is other than an organometallic catalyst. In some embodiments, the water oxidation electrocatalyst is a heterogeneous catalyst. In some embodiments, the water oxidation electrocatalyst is of non-precious metals. In some embodiments, the water oxidation electrocatalyst is a perovskite, a polyoxometalate, or a metal-organic framework. In an embodiment, for example, the water oxidation electrocatalyst is a solid, such as solid particles having physical dimensions less than or equal to 100 μm, or optionally less than or equal to 10 μm. In some embodiments, the water oxidation electrocatalyst is a nanostructured solid, such as a solid having nano-features with dimensions less than or equal to 1 μm, or optionally less than or equal to 200 nm. For example, the water oxidation electrocatalyst may comprise one or more transition metals. In another example, the water oxidation electrocatalyst is an inorganic catalyst. In another example, the water oxidation electrocatalyst is a catalyst material other than an organometallic catalyst. In some embodiments, the water oxidation electrocatalyst may be a nickel-iron layered double hydroxide, oxide, or oxy(hydroxide). In some embodiments, the water oxidation electrocatalyst may be a nickel-manganese layered double hydroxide, oxide, or oxy(hydroxide).

Initial studies underlying the present disclosure used an exemplar metal-based water oxidation electrocatalyst, specifically, one comprised of the metals nickel and iron (“NiFe”). NiFe water oxidation catalysts have been known for decades. In 2014 and 2016, one of the present inventors and her collaborators reported an improved version of a NiFe water oxidation electrocatalyst, using laser-made nanosheets of [NiFe]-layered double hydroxide. See, Hunter, et al., J. Am. Chem Soc., 2014, 136(38):13118-13121 (hereafter, “Hunter 2014”); Hunter, et al., Energy Environ Sci., 2016, 9(5):1734-1743. The [NiFe]-layered double hydroxide nanocatalyst made by pulsed laser in liquids synthesis outperforms analogous materials prepared by conventional methods. Forsythe, et al., Chem. Rev. 2021, 121(13):7568-7637.

Intrinsically more active catalysts aid the efficient and complete abstraction of fluorine atoms from PFAS. Smaller catalysts provide a higher surface to area ratio, providing more active sites of the catalysis, turning over more material, and that are intrinsically more active. Accordingly, in some embodiments, the water oxidation catalyst is provided in the form of a NiFe nanocatalyst made by pulsed laser in liquids synthesis, or nanocatalysts of other metals, made as described in the papers referenced above.

Following the initial studies reported in the Examples, studies were conducted using a second exemplar water oxidation electrocatalyst, this one a nickel and manganese (“NiMn”)-layered double hydroxide. Like the first exemplar water oxidation electrocatalyst, the NiMn electrocatalyst was able to dissociate fluorines from PFAS in a predominantly aqueous electrolyte. The NiMn electrocatalyst was, however, surprisingly three times better than the NiFe-layered double hydroxide at degrading PFAS than was the NiFe electrocatalyst. In some preferred embodiments, the water oxidation catalyst is provided in the form of a NiMn nanocatalyst made by pulsed laser in liquids synthesis.

As persons of skill are aware, while layered double hydroxides were used in the studies described above, oxides and oxy(hydroxides) will perform similarly, as all these materials turn into the oxy(hydroxide) under anodic electrocatalysis and all form materials that are similar under cathodic electrocatalysis. Thus, while layered double hydroxides are a preferred material for use as an electrocatalyst in some embodiments, it is contemplated that in other embodiments, metal oxides and oxy(hydroxides) can be used instead.

More generally, the water oxidation electrocatalyst can be nanostructured layered double hydroxide solid, an oxide solid, an oxy(hydroxide) solid, a perovskite, a polyoxometalate, or a metal-organic framework. In some embodiments, the electrocatalyst is a nanostructured layered double hydroxide solid, oxide solid, or oxy(hydroxide) solid which contains an effective amount of one or more transition metals, a post-transition metal, or both a transition metal and a post-transition metal. The one or more transition metals can be selected from the periodic table first-row transition metals. The post-transition metal is selected from the group consisting of bismuth, gallium, indium, tin, thallium, and lead. In some embodiments, the nanostructured layered double hydroxide solid, oxide solid, or oxy(hydroxide) solid comprises a divalent metal mixed with an effective amount of a transition metal, a post-transition metal, or both a transition metal and a post-transition metal. It is noted that any divalent metal can be used, but nickel is the best performing metal tested as of the writing of this disclosure.

It is noted that a considerable amount of information is available in the art with regard to metals suitable for use as electrocatalysts, including Hunter, Gray, and Mueller, Chem. Rev., 116:14120-14136 (2016); DOI: 10.1021/acs.chemrev.6b00398, the entirety of which is incorporated herein by reference. It is expected that, in view of the extensive teachings in the art, the person of skill can choose the particular materials they wish to employ as a water oxidation electrocatalyst in different embodiments of the inventive systems and methods.

In some embodiments, the water oxidation catalyst in the inventive systems and methods may be used with conventional electrodes. As mentioned above, however, nano-sized catalytic particles are more efficient at removing fluorine atoms from PFAS, and these nanoparticles are preferably positioned on an electrode with a high surface area. In preferred embodiments, therefore, nanoparticles of the electrocatalyst are preferably immobilized on a high surface area electrode support.

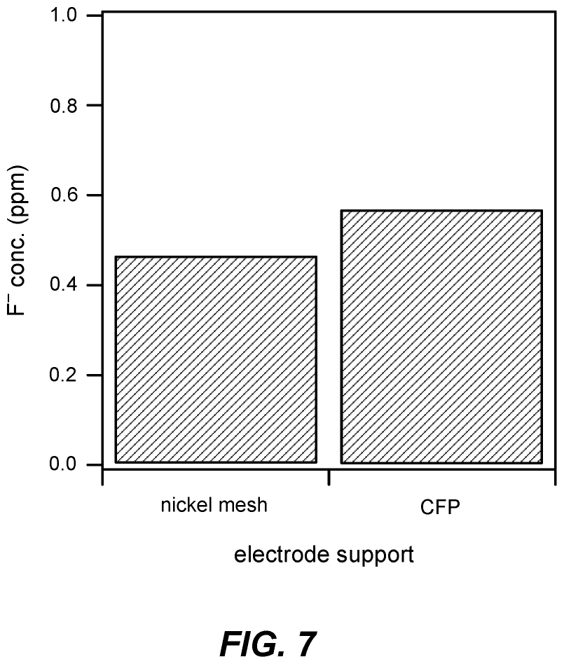

Typically, in embodiments in which an anodic bias is used, the water oxidation electrocatalyst is placed on the anode. In some preferred embodiments, hydrophilic carbon fiber paper (“CFP”) is the electrode support, as it is inexpensive, electrically conductive, chemically inert, nontoxic, robust, and scalable. As described in the Hunter application, however, the electrode on which the water oxidation electrocatalyst is placed (typically the working electrode) may be fluorine-doped tin oxide (“FTO”), indium tin oxide (ITO), an allotrope of carbon other than carbon fiber (e.g., graphite, glassy carbon, or pyrolytic carbon), a metal (e.g., Pt, Ti, Ni, Au), or any combination of these. As reported in the Examples and shown in FIG. 7, a study comparing the degradation by electrocatalysis of an exemplar PFAS compound using an electrocatalyst supported by a nickel mesh to the electrolysis of the same exemplar PFAS by the same electrocatalyst supported on a CFP support resulted in the same order of magnitude in degradation of the PFAS compound.

The water oxidation electrocatalyst may be drop cast from a solution onto the anode (or, in a system in which a cathodic bias is to be used, the cathode), and the drop-cast solution allowed to dry, thereby immobilizing the solid water oxidation electrocatalyst on the anode or cathode. Similarly, a suspension or a dispersion of the water oxidation electrocatalyst may be prepared and then drop-cast onto the anode or cathode. The water oxidation electrocatalyst may also be immobilized on the anode or cathode by a solution coating technique, a vapor deposition technique, or other techniques known in the art and appropriate to the selected water oxidation electrocatalyst, such as, but not limited to, doctor blading, dip coating, spin coating, electrophoretic deposition, pulsed laser ablation, pyrolysis, sputtering, thermal evaporation, and laser ablation. The water oxidation electrocatalyst may be provided on the electrode (e.g., the anode or cathode) at a selected loading density selected over the range of 1 μg/cm² to 1 g/cm². An applied electric potential may be applied to the water oxidation electrocatalyst indirectly, that is, via applying the electric potential to the anode or to the cathode with which the water oxidation electrocatalyst is in electronic communication or on which the water oxidation electrocatalyst is immobilized.

As discussed further below, studies underlying the present disclosure discovered that the bias applied to the system can be a cathodic bias rather than the anodic bias usually used in electrocatalytic systems. Accordingly, either bias can be applied to the water oxidation electrocatalyst.

### Anodic Bias

In initial studies underlying the present disclosure, an Ag/AgCl reference electrode was used, and a constant potential of +1.2 V versus Ag/AgCl was applied. As persons of skill are aware, a “constant potential” means that there is a constant potential applied, no matter if it is positive or negative. “Anodic bias” means that a positive constant potential is applied; as “bias” is by definition a fixed DC voltage. The pH of an aqueous solution describes its proton concentration; a pH of 0 means that there are 1 mol per liter of protons in water. In aqueous systems, a “normal hydrogen electrode,” or “NHE,” which is pH-dependent, can be used to measure potential. In non-aqueous systems, however, there is not enough water present for the pH scale is be useful. Accordingly, electrochemists typically use a “standard hydrogen electrode”, or “SHE,” rather than a “normal hydrogen electrode,” or “NHE,” and reference or convert back to pH 0 aqueous conditions. Methods of correlating SHE measurements and NHE measurements are known in the art.

For purposes of conducting electrocatalysis of PFAS with water oxidation electrocatalysts by the methods and systems of the invention, it is expected that a potential range of 0.5 V to 5 V versus SHE will work. In some embodiments, the potential range is 0.75 V to 3 V vs. SHE. In some embodiments, the potential range is 1.0 V to 2 V vs. SHE. In some embodiments, the potential range is 1.0 V to 1.7 V vs. SHE. In some embodiments, the potential is 1.25 V±0.20 vs. SHE. In some embodiments, the potential is 1.25 V±0.10 vs. SHE.

### Cathodic Bias

As noted in the preceding section, initial studies underlying the present disclosure used an anodic bias to cause electrocatalysis of an exemplar PFAS compound. Further studies showed that the bias applied to the system can be a cathodic bias rather than the anodic bias usually used in conducting electrocatalytic reactions.

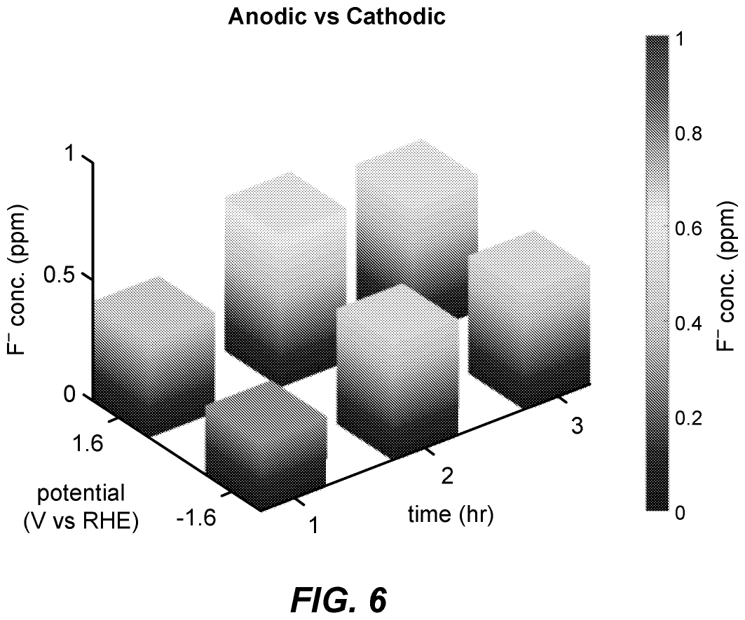

A study was conducted to compare the effect on an exemplar PFAS compound of applying a cathodic (negative) bias to the electrocatalytic cell to the effect of applying an anodic (positive) bias to a like cell. The results are shown in FIG. 6. As can be seen, while the results for the anodic cell were somewhat better than those for the cathodic cell at each time point tested, the results for the two types of bias are within the same order of magnitude.

Accordingly, while it is anticipated that a practitioner will typically choose to use an anodic bias, for its slightly better results, either bias can be applied to the water oxidation electrocatalyst to subject a PFAS or another target compound to electrocatalysis. The applied electric potential can therefore be either negative or positive, with a range of values from −5 V to 5V versus standard hydrogen electrode (“SHE”), provided that the potential is not an open circuit potential. In some embodiments, the potential range is −0.75 V to −3 V vs. SHE. In some embodiments, the potential range is −1.0 V to −2 V vs. SHE. In some embodiments, the potential range is −1.0 V to −1.7 V vs. SHE. In some embodiments, the potential is −1.25 V±0.20 vs. SHE. In some embodiments, the potential is −1.25 V±0.10 vs. SHE PFAS

Initial studies underlying the disclosure used as an exemplar PFAS the compound perfluorooctanoic acid (“PFOA”), as it is a widely studied member of the PFAS group that has been used worldwide as an industrial surfactant and is also one of the most common PFAS compounds found in the blood serum of Americans studied to date. PFOA has a carboxylic acid “head group” and a perfluorinated, n-octyl “tail group” and is therefore considered a perfluoroalkyl carboxylic acid. Given the structural similarity with other perfluoroalkyl carboxylic acids, the results oxidizing PFOA are expected to obtain with other perfluoroalkyl carboxylic acids, such as perfluorononanoic acid (“PFNA”) and perfluorodecanoic acid (“PFDA”), as well as with other perfluoroalkyl acids. Further, since the C—F bond in PFOA is the same in PFAS more generally, which are characterized by their perfluoroalkyl composition, PFOA shares structural identity with other members of the PFAS group. It is therefore expected that results obtained in removing fluorine atoms from PFOA will be true with respect to the fluorine atoms of other PFAS. Any particular PFAS compound of interest can, of course, be readily tested by the method set forth in Example 1 to determine whether its fluorine atoms can be dissociated by the water oxidation catalyst while in the electrocatalyst aqueous solution.

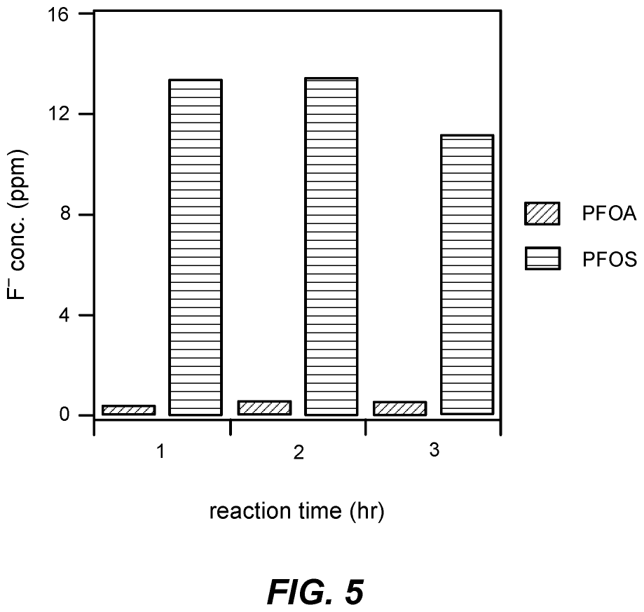

To confirm that the results obtained by subjecting PFOA to electrocatalysis in fact indicated that other PFAS would be susceptible to electrocatalysis using the inventive systems and methods, we ran an experiment testing the ability of the system to degrade a second exemplar PFAS, perfluorooctanesulfonic acid, or “PFOS.” As shown in FIG. 5, not only did the system degrade PFOS, but it did so at a rate approximately an order of magnitude higher than the rate at which a parallel system degraded PFOA. The study indicates that, while the rate at which individual PFAS compounds (and, by extension, other compounds that the practitioner wishes to degrade) will vary depending on characteristics of the individual PFAS such as the various bonds that make it up, the systems and methods are indeed broadly applicable to PFAS in general and, by extension, to other compounds that the practitioner wishes to degrade.

Studies were also conducted to confirm that the inventive methods and systems would dissociate fluorines from a PFAS compound when the PFAS compound was present in the electrolyte at different concentrations. Studies were conducted with (1) 10 mM PFOA in an electrolyte of otherwise pure water with 100 mM KOH, (2) with 5 mM PFOA in the same electrolyte, and (3) with 0.9 mM PFOA in pH 9.3 aqueous borate buffer, a commonly used electrolyte. All the studies showed dissociation of fluorine from the PFOA, evidencing the ability of the inventive process to degrade an exemplar PFAS provided at a range of concentrations varying by an order of magnitude, in two different electrolytes.

Degradation of Environmental Pollutants Other than PFAS

The covalent bond between a carbon atom and a fluorine atom is one of the strongest single bonds in chemistry, due in part to the high electronegativity of fluorine compared to that of carbon, which gives the C—F bond a significant polarity. According to the Wikipedia article on the bond, the C—F bond can have a bond dissociation energy (BDE) of up to 130 kcal/mol, which the article states is higher than that of other carbon-halogen bonds, such as those of a carbon-chlorine bond, a carbon-bromine bond, or a carbon-iodine bond. The bonds between a carbon atom and fluorine are also known to increase in strength as more than one fluorine is bound to the same carbon. In some embodiments, the environmental pollutant to be degraded by the inventive systems and methods does not have more than one fluorine atom bonded to one carbon. In some embodiments, the environmental pollutant is not a fluoroalkane.

As the studies underlying the present disclosure show that the inventive systems and methods can cause the dissociation of fluorine ions from the carbon atoms of PFAS compounds, reflecting the breaking of the strongest of the carbon-halogen bonds, the person of skill will recognize that the inventive systems and methods will work equally well, if not better, in breaking bonds between carbon atoms and other halogens, as well as other bonds weaker than carbon-fluorine bonds, such as carbon-nitrogen or carbon-oxygen bonds. Thus, in some embodiments, the inventive systems and methods are expected to be useful in degrading environmental pollutants with bonds other than carbon-fluorine bonds.

As noted earlier, in addition to PFAS, it is therefore expected that the systems and methods taught herein will be widely useful in degrading other pollutants present in groundwater or surface waters, the removal of which pollutants has not been possible using the techniques available to date. Thus, it is expected that the systems and methods described in this disclosure can be used to degrade environmental pollutants such as dioxins, polychlorinated biphenyls (“PCBs”), pesticides (such as herbicides, insecticides, fungicides, rodenticides, and algicides), volatile organic compounds, plasticizers, and chlorinated solvents. For convenience of reference, a particular environmental pollutant that a practitioner wishes to degrade by an embodiment of the inventive systems or methods is sometimes referred to herein as a “target compound” or a “compound of interest.” While it is believed that the inventive systems and methods will degrade most if not all environmental pollutants, the ability of the systems and methods to degrade any particular environmental pollutant can be readily tested by subjecting the environmental pollutant of interest to electrocatalysis following the procedure described in Example 1, below, with the environmental pollutant substituting for the PFAS tested in that Example. Degradation of the environmental pollutant by electrocatalysis demonstrates that that particular environmental pollutant is suitable for degradation by the inventive systems and methods under those conditions. If the environmental pollutant is not degraded under the conditions described in Example 1, the test may be repeated using an applied potential bias of +5V vs. a Ag/AgCl reference electrode (if an anodic bias is preferred) or of −5V vs. a Ag/AgCl reference electrode, if a cathodic bias is preferred). If the environmental pollutant is still not degraded under the stronger applied electric potential, it is not a compound susceptible to degradation by the inventive systems and methods.

### Solutions and Electrolytes

As noted above, in some embodiments, the systems and methods of the invention subject PFAS to electrocatalysis in an electrolyte solution that is predominantly aqueous, which for purposes of this disclosure means that the solution is 46 vol % or more water, and is preferably 50 vol %, 60 vol %, 65 vol %, 70 vol %, 75 vol %, 80 vol %, 85 vol %, 90 vol %, 91 vol %, 92 vol %, 93 vol %, 94 vol %, 95 vol %, 96 vol %, 97 vol %, 98 vol %, 99 vol %, or more, water, with solutions that are 60 vol % or more water being preferred over those that are less than 60 vol % water. Solutions of liquids contaminated with PFAS or another target compound, which solutions have a lower vol % of water than that desired by the practitioner, can of course, simply have more water added to them until they reach the percentage of water desired by the practitioner.

In some embodiments, in which the inventive systems and methods are used to degrade pollutants other than PFAS, particularly those that are not soluble in water, will typically use an electrolyte solution of which from 50 vol % to 95 vol % is water, with some or all of the rest of the electrolyte solution being a non-aqueous solvent in which the pollutant is soluble. To reduce the amount of non-aqueous solvent that has to be distilled off or otherwise recycled with respect to degrading a pollutant present in a particular sample, the practitioner will typically add only enough non-aqueous solvent to dissolve the pollutant in the sample.

As practitioners are aware, electrolysis requires an electrical current to flow by the movement of ions through a solution towards electrodes partially or wholly immersed in the solution. Thus, it is understood that, if the electrolyte solution does not already have sufficient ions present in the solution to allow electrocatalysis to occur, a compound that dissociates in water to provide the necessary ions will be added. In studies underlying the present disclosure, for example, potassium hydroxide (KOH) was added to provide the necessary ionic conditions. Salts, bases other than KOH, acids, and other ionic compounds can be used to provide the necessary ions. If the electrolyte solution also contains a non-aqueous solvent, it is understood that the practitioner will determine if there are enough ions to allow the non-aqueous phase to serve as an electrolyte and, if not, to add a salt or other reagent until a sufficient ion conductivity in the liquid has been reached.

The particular choice of ionic compound to provide the necessary ions will be guided in part by the metals of the particular water oxidation electrocatalyst the practitioner has selected for use. Some non-precious metal water oxidation electrocatalysts, such as the exemplar NiFe electrocatalyst used in some studies reported in the Examples, are not stable in acid. Such electrocatalysts are provided with a solution in which the ions are provided by a base, a salt, or a combination of a base and a salt. Other water oxidation electrocatalysts, such as those made from manganese, iridium (for example, iridium dioxide), and ruthenium (for example, ruthenium oxide), are stable in acid solutions and an acid can be used to provide ions sufficient to allow ionic conductivity to the electrolyte solution. In some embodiments, the water oxidation electrocatalyst is a mixture of iridium and ruthenium.

As persons of skill will be aware, in solutions that are 50 vol % or more water, thereby lowering the percentage of any non-aqueous solvent present, the practitioner will wish to check that the electroconductivity of the electrolytic solution is maintained. Some studies underlying the present disclosure tested the ability of the water oxidation electrocatalyst to dissociate fluorine from an exemplar PFAS in solutions in which the water content was 40 vol %, 45 vol %, or 50 vol %, with the remaining percentage of solution made up of an exemplar organic solvent, acetonitrile. In these studies, electroconductivity was maintained by adding 100 mM KOH to the aqueous phase and adding 100 mM lithium perchlorate to the organic phase. To confirm that the particular source of the ions was not critical, some studies were conducted using 100 mM pH 9.2 aqueous borate buffer instead of KOH, and showed success at releasing fluorine from the exemplar PFAS. It is known in the art that 100 mM of any strongly dissociating base, acid, or salt is sufficient to impart adequate electroconductivity. See, e.g., A. J. Bard, L. R. Faulkner, ELECTROCHEMICAL METHODS: FUNDAMENTALS AND APPLICATIONS, 2nd ed., Wiley (New York, 1980).

As electrolysis has been conducted for almost two centuries, materials suitable for forming solutions for conducting electrolysis are well known and it is expected that practitioners are well familiar with selecting bases, salts, acids, other compounds to allow ions to flow in the electrolyte, with concentrations of ions for making the predominantly aqueous solution into an electrolyte suitable for use in electrocatalysis, and with how to measure those concentrations. It is also assumed that persons of skill are familiar with maintaining electroconductivity of the electrolyte solution and can readily do so using any particular combination of water and a non-aqueous solvent to allow the electrolyte solution to serve as an electrolyte permitting the electrocatalysis of PFAS or other compounds having a single covalent bond between a carbon atom and a halogen atom, a carbon atom and a nitrogen atom, or a carbon atom and an oxygen atom. In some embodiments, the compound to be degraded has a single covalent bond between a carbon atom and a halogen atom. In some embodiments, the compound to be degraded has a single covalent bond between a carbon atom and a nitrogen atom. In some embodiments, the compound to be degraded has a single covalent bond between a carbon atom and an oxygen atom. For clarity, the term “single covalent bond” is used here to indicate that the bond being broken by the electrocatalysis is a single bond between the two atoms described, as opposed to there being a double bond between the two atoms, not that there is, for example, only one carbon-nitrogen or one carbon-oxygen bond in the molecule to be degraded.

In laboratory settings, a compound to be tested for degradation by electrocatalysis is typically added to a container holding purified water, and a salt or other reagent is then added to create a solution with an ionic conductivity sufficient for the solution to serve as an electrolyte. Stated another way, a salt or other reagent is added to provide an ion concentration enabling charge transport.

In some embodiments of the inventive systems and methods, the remediation of water contaminated by environmental pollutants is conducted by simply providing the contaminated water directly to a container which either already holds the electrocatalytic apparatus or on which an electrocatalytic apparatus can be disposed, with the water to be remediated itself becoming the electrolyte. The ion concentration of the contaminated water is typically checked, either prior to being provided to the container or while in the container, to determine whether the concentration of ions is sufficient for the water (i.e., the solution of water contaminated by the pollutant) to serve as an electrolyte, that is, that it has sufficient ionic conductivity to serve as an electrolyte. If it does not, the concentration of ions can be adjusted by the practitioner by standard methods, such as adding salts to the water to increase the ion concentration to a level allowing the water to serve as an electrolyte. As noted elsewhere in this disclosure, electrocatalysis has been conducted in the art for over a century, and persons of skill are well familiar with how to measure ion concentrations and to determine whether the concentration of ions present in a particular solution is sufficient for it to serve as an electrolyte.

Depending on the particular embodiment chosen by the practitioner, the solution of water containing the pollutant may be, except for the pollutant and any added salts, almost pure water, or may have a percentage of non-aqueous solvent or solvents. For example, the solution may be 65% water and (ignoring the presence of the pollutant to be degraded and any salts added to adjust the concentration of ions) 35% non-aqueous solvent, 70% water and (ignoring the presence of the pollutant to be degraded) 30% non-aqueous solvent, or 90% water and (ignoring the presence of the pollutant to be degraded) 10% non-aqueous solvent.

Some environmental pollutants are not soluble in water, and will typically contaminate soil. Other non-water soluble pollutants typically settle in river beds or lake bottoms, where they can enter the food chain or be stirred up by dredging or by ship activity. In some embodiments, non-water soluble pollutants that are soluble in organic solvents can be extracted from contaminated soil or mud scooped from river beds or the like and the organic solvent containing the extracted pollutant can then be used as the non-aqueous solvent in electrolyte solutions, such as those described in the preceding paragraph. For example, dioxins are not water soluble, but can be extracted from contaminated soil by organic solvents such as methanol, ethanol, and acetone. The organic solvent, bearing dioxin extracted from the soil, can be placed in a container with water to form a solution that is, for example, 80 vol % or more water, and 20 vol % or less organic solvent with dissolved dioxin, now in a liquid phase, and the solution can then be subjected to electrocatalysis. PCBs are soluble in many alcohol-water mixtures, including mixtures of water, ethanol, and 1-propanol. See, e.g., Li and Andren, Environ. Sci. Tech., 1994, 28:47-52. The ethanol, 1-propanol, or other alcohol bearing PCBs dissolved in it can be placed in a container with water to form a solution that is, for example, 80 vol % or more water, and the PCBs, now in a liquid phase in the alcohol, subjected to electrocatalysis. Information about the degree to which most important environmental pollutants are soluble in water, in polar protic solvents, or in aprotic solvents is known in the art, and it is expected that the practitioner can choose an appropriate non-aqueous solvent for the particular environmental pollutant or pollutants whose presence the practitioner wishes to reduce. As noted earlier, any particular solution of water and an organic solvent can be readily tested for its ability to degrade a particular pollutant or other compound of interest by placing the pollutant or other compound of interest in an electrocatalytic system described in the Examples and applying an electric potential. Degradation of the pollutant or other compound of interest by the electrocatalytic system indicates that that particular solution is suitable for degrading the pollutant or other compound of interest.

For environmental pollutants that have carbon-halogen bonds, it is expected that halogen ions will be released from the pollutants and that those ions can be mineralized, as described herein for the fluorines released from the exemplar PFAS compounds subjected to electrocatalysis in the Examples below. For other pollutants, it is expected that the degradation products resulting from electrocatalysis of the pollutant will be less toxic than the starting compound, less persistent in the environment, or both.

As noted, in some embodiments, organic solvents such as alcohols or acetone may be used as a non-aqueous part of the electrolyte solution. The organic solvent may be recycled and reused by distilling the organic solvent from the electrolyte after all or most of the dissolved pollutant has been degraded.

### Conducting Electrocatalysis of PFAS and Mineralization of Released Fluorines or Ionic Forms Thereof

It is noted that “electrolysis” is used in this disclosure in its usual sense to refer to the decomposition of a selected compound (such as the exemplar PFAS compounds used in the Examples) by the application of electric energy. As the electrolysis of PFAS and other compounds in embodiments of the inventive methods and systems involves the use of a metal water oxidation electrocatalyst, the methods of the invention are sometimes referred to herein more specifically as “electrocatalysis.”

Electrocatalysis is a standard procedure and it is assumed that persons of skill are familiar with conventional materials and methods for conducting it. Accordingly, only some features of the procedure will be touched on here. As practitioners will appreciate, electrolysis is typically conducted in a container holding an electrolyte and, usually, an analyte or reactant of interest. In applications relevant to the present disclosure, the analyte or reactant of interest is a PFAS compound or two or more PFAS compounds. As described in, for example, “Overview of Reference Electrodes and Alternative Reference Electrodes” (Pine Research Instrumentation, Durham, NC, document no. DRK10053 (Rev001, 2016)), at least two electrodes are electrically connected by the electrolyte; one, sometimes referred to as the “working electrode,” which allows electron transfer to the analyte or reactant, and a counter electrode which maintains electroneutrality by allowing a reaction of the electric sign (i.e., positive or negative) opposite to that of the electron transfer to the analyte or reactant. The voltage is typically referred to as the potential difference between the working electrode and the counter electrode. As it is known that the potential difference between these two electrodes can change during the electrolysis for a variety of reasons, an additional counter electrode, referred to as a “reference electrode,” is typically included. The reference electrode has a potential that does not change, and allows accurate control of the potential of the working electrode. In studies underlying the present disclosure, an Ag/AgCl reference electrode was used, with a constant potential of +1.2 V versus Ag/AgCl was applied. A variety of reference electrodes are known, however, and it is expected that the person of skill can readily select a reference electrode for use in the electrocatalytic systems and methods taught herein.

The systems and methods of the present disclosure comprise a container in which an electrolyte electrically connects a working electrode, counter electrode, and, preferably, a reference electrode. A water oxidation electrocatalyst is disposed on the working electrode and is typically immobilized thereon. As used in standard practice, the “working electrode” is the one on which the desired reaction takes place.

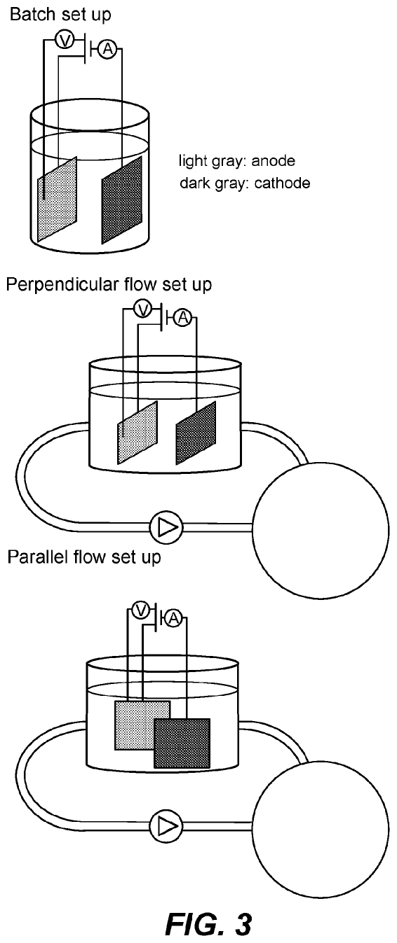

As used herein, the terms “water oxidation catalyst” and “water oxidation electrocatalyst” mean the same thing. FIG. 3 presents illustrations of three typical systems of the present disclosure. The top illustration shows a container in which an electrolyte comprising a predominantly aqueous solution and containing, for this example, one or more PFAS compounds. The light gray electrode on the left-hand side is the anode, with a reference electrode (vertical line) disposed in close proximity. The dark gray electrode is the cathode. Current is applied to flow through the electrolyte to cause catalysis of the PFAS dissolved in the electrolyte. As this embodiment is set up to contain the electrolyte and not to allow a flow of electrolyte into and then out of the container, it is referred to herein as a “batch” set up or a “batch” process. The middle and bottom illustrations in FIG. 3 depict embodiments in which the electrolyte solution can flow from the container in which the electrocatalysis is conducted to a second container, in which cations can be added as described below to precipitate from the solution any fluoride stemming from fluorine atoms released from C—F bonds in the PFAS during electrocatalysis. Precipitating the fluoride in the second container avoids concerns that the precipitate will coat the electrodes in the first container, thereby reducing their effectiveness. In the embodiments shown, the second container has a second hose or tube allowing the solution remaining following the precipitation to be returned to the first container if desired.

As known in the art, the reaction time to complete electrolysis is dependent on the geometry of the particular apparatus being used, such as the electrode size with respect to the electrolyte volume, and whether the apparatus is configured as a batch process or a flow process. The electrolysis is typically conducted for a time selected by the practitioner, such as 15 minutes, 30 minutes, 45 minutes, 1 hour, 2 hours, 3 hours, 4 hours, 8 hours, 12 hours, 16 hours, or 24 hours, guided in part by the geometry and set up of the apparatus. In some embodiments, the electrocatalysis can be set up in a system in which electrolyte containing PFAS flows continuously over the electrocatalyst, then into a container in which fluorine that has dissociated from the PFAS is precipitated out to remove it from the electrolyte, following which the electrolyte then returned to the original container and again allowed to contact the electrocatalyst to degrade any PFAS remaining in the electrolyte. A similar process may be used to degrade PCBs or other compounds comprising a carbon-halogen bond, a carbon-nitrogen bond, or a carbon-oxygen bond which the practitioner wishes to degrade.

Based on studies underlying the present disclosure, fluorine released from the PFAS dissolves in the predominantly aqueous solution, and is present as fluoride in the electrolytic solution. No fluorine gas bubbles were observed leaving the container during the studies.

Once the electrolysis has been conducted for a time or to a point determined by the practitioner, fluoride released into the electrocatalysis solution can be precipitated to mineralize it in a form that is less toxic than the PFAS in which it was previously present. This can be accomplished by adding to the predominantly aqueous solution ions of atoms that will bind fluorine more avidly than hydrogens in the water bind fluorines that have dissolved into the predominantly aqueous solution, thereby forming a solution comprising hydrofluoric acid.

In some embodiments, the ions of such atoms are added by adding a second aqueous solution in which has been dissolved a compound that provides ions of the desired atoms. In studies underlying the present disclosure, a saturated aqueous CaCl₂ solution was added to the aqueous solution containing fluorides stemming from fluorine released by electrocatalysis from an exemplar PFAS, resulting in the formation of fluorine-containing calcium solids. In other embodiments, a compound can be added directly to the first aqueous solution to add the desired cations. Calcium was used in the studies underlying the present disclosure as it is both inexpensive and abundant. Other cations that form water-insoluble fluorides, however, can be used to mineralize the fluorides. In some embodiments, the cations used are of the alkaline earth metals, Mg²⁺, Sr²⁺, and Ba²⁺. Beryllium is not suitable, both because it is toxic and because BeF₂ is very soluble in water and creation of BeF₂ would not result in mineralizing the fluorine. In some embodiments, the cations are of lithium, Li⁺. Other metal cations also form water-insoluble fluorides and thus can be used include zirconium, Zr⁴⁺, gallium, Ga³⁺, copper, Cu²⁺, zinc, Zn²⁺, lead, Pb²⁺, vanadium, V³⁺, and chromium, Cr³⁺. The oxidation states of the metal cations are specified, as they matter for the water-solubility of the resulting fluorides.

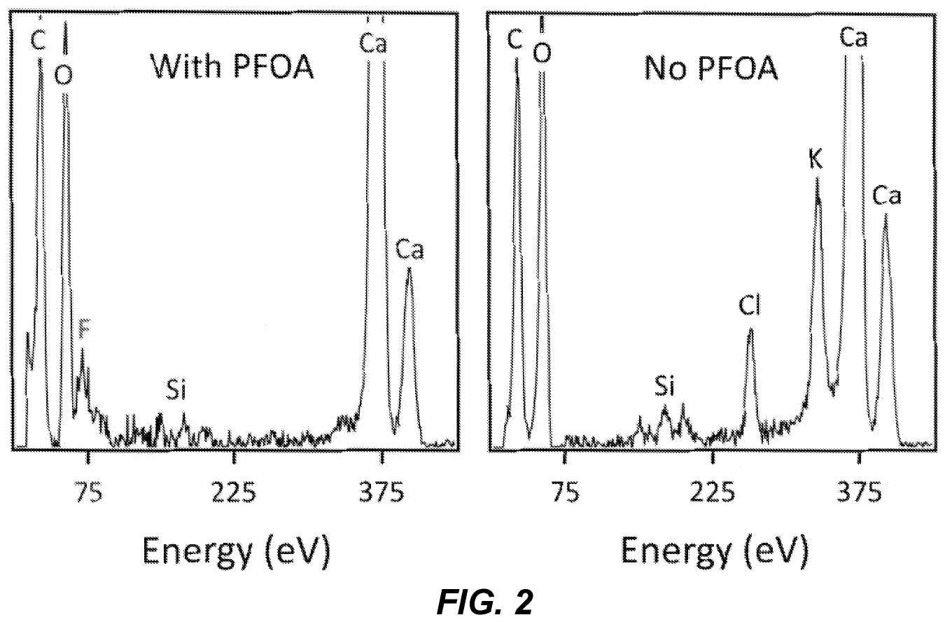

In studies of electrocatalysis of an exemplar PFAS, PFOA, underlying the present disclosure, fluorine released from PFOA was precipitated by adding calcium chloride solution to the electrolyte, resulting in a white precipitate. As discussed in the Examples, and as shown in FIG. 2, analysis of the precipitate revealed that fluorine was present in the precipitate, evidencing the removal of fluorine from the exemplar PFAS, which was the only source of fluorine in the experimental set-up.

### Batch and Flow Systems for Conducting Electrocatalysis of PFAS Using Water Oxidation Catalysts

The container in which the electrolysis is conducted can be two cylinders electrically connected by an electrolyte, as in a Hoffman voltameter, but is more typically a tank, vat, tub, or other container that can hold the amount of predominantly aqueous solution which the practitioner wishes to use. (For ease of reference, these various forms in which the predominantly aqueous solution containing the PFAS or other compound to be degraded can be subjected to electrocatalysis will be referred to simply as a “container” unless reference to a specific type is required.) FIG. 3 presents three embodiments of systems using a water oxidation catalyst to remove fluorine atoms from a PFAS compound. The top panel of FIG. 3 shows a batch set up, in which the PFAS is subjected to electrolysis in a container. In some embodiments, the fluorine released from the PFAS is precipitated by adding a compound that will dissolve in the predominantly aqueous solution to provide atoms of the desired type to react with the fluorine in the solution (for convenience, such compounds will simply be referred to as a “precipitation compound”). In other embodiments, the fluorine released from the PFAS is precipitated by adding to the container a second solution, in which the compound just described has already been dissolved (for convenience, such compounds will simply be referred to as a “precipitation solution”). The resulting precipitate is understood to contain fluorine from the PFAS as a component and is sometimes referred to herein as the fluorine having been “mineralized,” or as “mineralized fluorine.”

Precipitation of the fluorine in the predominantly aqueous solution within the container may allow the precipitate to coat the water oxidation catalyst, particularly in embodiments in which the water oxidation catalyst is provided as nanoparticles immobilized on an electrode. Accordingly, in preferred embodiments of batch processes, after the electrocatalysis of the PFAS has reached a point (in time or in electrocatalysis of the PFAS), the electrodes are removed from the predominantly aqueous solution before adding a precipitation compound or precipitation solution to the predominantly aqueous solution. In some embodiments, the resulting mineralized fluorine is then removed from the container before subjecting more PFAS to electrocatalysis. The same procedure can be used to mineralize and then remove halogens produced by non-PFAS compounds containing a carbon-halogen bond.

In another set of embodiments, the PFAS or other compound may be subjected to electrocatalysis in a flow process. Referring again to FIG. 3, the middle and bottom cartoons depict flow processes. Both cartoons show a first container initially holding the predominantly aqueous solution, two electrodes for subjecting PFAS to electrocatalysis, and a reference electrode. Although not shown in the cartoon, the anode is understood to have disposed on it a water oxidation catalyst. Both cartoons depict a first connection from the first container fluidly connecting it to a second container and, in the embodiment shown, with a second connection fluidly connecting the second container back to the first container. An arrow in the first connection shows the direction of flow of the predominantly aqueous solution from the first container through the first connection to the second container. The fluid connection between the first container and the second container can be, for example, a hose or a tube. The middle diagram depicts an embodiment in which the electrodes are disposed in the container perpendicular to the direction of the fluid flow, while the bottom diagram depicts an embodiment in which the electrodes are disposed in the container parallel to the direction of the fluid flow. In some embodiments, there is a valve or similar device for preventing the predominantly aqueous solution from exiting the first container until after electrocatalysis of the PFAS has reached a point chosen by the practitioner. The valve or other device keeping the predominantly aqueous solution from entering into the first connection can then be opened and the predominantly aqueous solution, containing fluorine released from the PFAS by the electrocatalysis. Once the second container has received the predominantly aqueous solution, a precipitation compound or precipitation solution can be added to precipitate the fluorine. Flow systems allow the fluorine to be precipitated without having to remove the electrodes from the first container and avoid any concerns that the precipitate might coat the water oxidation catalyst or the electrodes. If desired, once the fluorine has been precipitated from the predominantly aqueous solution, the predominantly aqueous solution in the second container can be returned to the first container through the second connection, either to subject any PFAS remaining in the predominantly aqueous solution that has not yet released fluorine from being subjected to a previous electrocatalysis, or to add provide an electrolyte solution for the electrocatalysis of additional PFAS. The second fluid connection from the second container back to the first container can, like the first connection be, for example, a hose or a tube. If the practitioner does not wish to return predominantly aqueous solution from the second container to the first container, the second connection connecting the second container to the first container can be omitted.

### Breaking C—F and C—H Bonds

The activation of C—F bonds of perfluoroalkyls by a water oxidation catalyst, such as the [NiFe]-layered double hydroxide used in the studies reported herein, is energetically possible. The bond dissociation energy at 298 K (“BDE₂₉₈”) to break an O—H bond, as needed in alkaline water oxidation, is 428 kJ mol-1. See, e.g., Kerr, Chem. Rev., 1966, 66(5):465-500. Previous work by one of the previous inventors has shown that the exemplar water oxidation catalyst used in the studies herein operates with 100% efficiency and low overpotential; and importantly, it contains only earth-abundant elements. See, Hunter 2014, supra; Hunter et al., Chem. Rev., 2016, 116(22):14120-14136 (hereafter, “Hunter Chem Rev 2016”). The reactive intermediate was identified as an iron(VI) cis-dioxo species. See, Hunter, et al. Joule, 2018, 2(4):1-17. The exemplar [NiFe]-layered double hydroxide electrocatalyst is highly active for the dissociation of O—H bonds; ergo, its oxidation strength is greater than 428 kJ mol-1. The energy required to dissociate a C—F bond is lower than that of an O—H bond (BDE₂₉₈=406 kJ mol⁻¹ for one C—F bond in CF₃—CF₃ (see, Kerr, supra), which serves here as a proxy for perfluorinated alkanes). Therefore, the breaking of C—F bonds of PFAS and ultimately their degradation to harmless products by electrocatalytic oxidation is indeed energetically possible. By extension, the breaking of other carbon-halogen bonds, such as C—Cl or C—I, is also energetically possible, as is the breaking of a C—O bond.

### Use of UV Light to Increase the Rate of Electrocatalysis

Conducting the electrocatalysis with ultraviolet (“UV”) light shining on the electrocatalyst improves the amount of fluorine released from PFAS per unit time and, by extension, will speed the electrocatalytic degradation of other compounds the practitioner wishes to degrade. Lamps, bulbs, and flashlights that produce UV light are well known and scores are commercially available.

Conveniently, the UV light can be provided by positioning one or more sources of the UV wavelength chosen by the practitioner to shine on the water oxidation electrocatalyst. If the electrode on which the water oxidation electrocatalyst is disposed has sides and the water oxidation electrocatalyst is disposed on more than one side, the UV light is preferably positioned to shine on each side bearing the water oxidation electrocatalyst. In some embodiments, more than one source of UV light is provided so that the entire area of the electrode bearing the water oxidation electrocatalyst receives UV light.

The study investigating whether the presence of UV light improved the electrocatalysis of PFAS employed light at a wavelength of 254 nm. Light of this wavelength was convenient for use in the study, in part because the absorbance of UV light of this wavelength is used as a water quality test that provides a quick measurement of the organic matter in water. The measurement technique works by shining ultraviolet light at 254 nm through a quartz cell that contains a representative water sample. Lamps, bulbs, and flashlights providing light of this wavelength are also used in a number of devices commercially sold to disinfect laboratory equipment.

It is expected that UV light of any wavelength considered to be UV will be suitable to improve the electrocatalysis of PFAS or of other compounds the practitioner wishes to degrade by electrocatalysis. In some embodiments, UV light with a wavelength from 10 nm to 400 nm is used to improve the electrocatalysis of PFAS. In some embodiments, UV light with a wavelength from 50 nm to 350 nm is used to improve the electrocatalysis of PFAS. In some embodiments, UV light with a wavelength from 100 nm to 350 nm is used to improve the electrocatalysis of PFAS. In some embodiments, UV light with a wavelength from 200 nm to 350 nm is used to improve the electrocatalysis of PFAS. In some embodiments, UV light with a wavelength from 200 nm to 300 nm is used to improve the electrocatalysis of PFAS. In some embodiments, UV light with a wavelength of 250 nm±10 nm is used to improve the electrocatalysis of PFAS.

### Non-Aqueous Solvents

A variety of non-aqueous solvents (e.g., organic solvents), such as acetonitrile, dimethyl sulfoxide (or “DMSO”), and ethanol, are known in the art. In general, any non-aqueous solvent that is miscible in water should be able to serve as the organic phase in a predominantly aqueous solution comprising the electrolyte in the electrocatalytic methods and systems in embodiments of the invention. With respect to the degradation of PFAS, any particular non-aqueous solvent can be readily tested for its suitability for use as the organic phase in any particular concentration in a predominantly aqueous solution comprising the electrolyte by conducting an assay using the conditions set forth in Example 1, below, with any adjustment to electroconductivity required due to the presence of the non-aqueous solvent, and determining if fluorines are dissociated from an exemplar PFAS during electrocatalysis in the presence of the particular concentration of the particular non-aqueous solvent being tested. With respect to the degradation of non-PFAS compounds, non-aqueous solvents that dissolve many environmental pollutants and other target compounds are well known. An assay can, however, readily be conducted with respect to any particular non-PFAS compound the practitioner wishes to degrade by electrocatalysis and any particular non-aqueous solvent the practitioner is considering using to see if the non-aqueous solvent is suitable for use with that non-PFAS compound by simply conducting an assay using the conditions set forth in Example 1, below, with any adjustment to electroconductivity required due to the presence of the non-aqueous solvent, and determining if breakdown products of the non-PFAS compound are produced during electrocatalysis in the presence of the particular concentration of the particular non-aqueous solvent being tested.

### Temperature

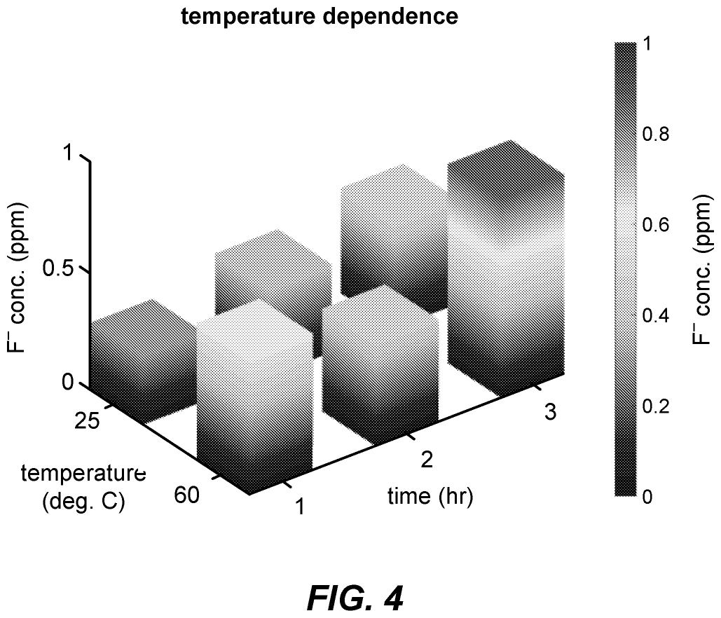

It is well known that most chemical reactions typically proceed more quickly if they occur at higher temperatures than they do at a lower temperature. To see how temperature affects the ability to degrade PFAS and, by extension, other compounds that the practitioner wishes to degrade, a study was conducted in which an exemplar PFAS, PFOA, was subjected to electrocatalysis at one of two temperatures: 25° C. or 60° C. The results are shown in FIG. 4. As can be seen in FIG. 4, electrocatalysis conducted at 60° C. outperformed electrocatalysis conducted at 25° C. at each time point measured. (To aid the reader, it is noted that it is common in electrocatalysis to see a dip in the production of an electrocatalytic product, such as the fluorine ion concentration measured in FIG. 4, at an intermediate time point. Without wishing to be bound by theory, in the art such dips are believed to be due to factors such as the differing transience of reactive species and intermediates as the electrocatalysis continues.)

In some embodiments, therefore, the electrocatalysis may be conducted using an electrolyte that has been heated above room temperature. In some embodiments, the electrolyte may be heated to 30° C., 40° C., 50° C., 60° C., 70° C., 80° C., 90° C., 99° C., or to a temperature between any two of the temperatures just listed. If desired, the temperature of the electrolyte can be raised to 100° C. or higher. In these embodiments, the container should be covered to avoid or reduce the loss of electrolyte, and the container and cover are preferably selected to be able handle both the heat and the pressure that will be produced by heating the electrolyte above its boiling point.

### Materials Forming the Electrode Supporting the Electrocatalyst

The electrocatalyst used to degrade PFAS and other compounds is typically performed by depositing the electrocatalyst on hydrophilic carbon fiber paper, or “CFP” (all references to “CFP” in this disclosure relate to hydrophilic CFP unless otherwise stated). To determine if CFP was a required component of an electrocatalytic system to degrade PFAS or other compounds of interest, a study was performed using a nickel mesh as a support for the electrocatalyst.

The results of the study are reported in Example 10, below, and in FIG. 7. As shown in FIG. 7, the electrocatalysis of an exemplar PFAS compound by an electrocatalyst disposed on the nickel mesh support was slightly less than, but within the same order of magnitude as, the electrocatalysis of the same exemplar PFAS by the same electrocatalytic material, but disposed on hydrophilic CFP, indicating that materials other than CFP that are electrically conductive can serve as a support for the electrocatalyst in some embodiments of the inventive systems and methods. In some preferred embodiments, the electrically conductive supports for the electrocatalyst are made of one or more metals. In embodiments in which the electrocatalyst is provided in the form of nanoparticles or other small particles, the electrically conductive supports are preferably in the form of a mesh, which provides a larger surface area to which the nanoparticles or other small particles can adhere and, consequently, a larger surface area over which electrocatalysis of the compound to be degraded can take place, thereby reducing the time needed to degrade any particular amount of the target compound.

Stirring Vs. Non-Stirring

A study underlying the present disclosure revealed that electrocatalysis of the target compound proceeded more quickly if the electrolyte solution was not stirred. Without wishing to be bound by theory, it is surmised that not stirring the electrolyte allows the target compound dissolved in the electrolyte to stay in contact with the electrocatalyst longer than in electrolytes that are stirred and that this more prolonged contact increases the rate at which the target compound is degraded.

### Definitions

Units not otherwise defined herein are defined as the units are defined by International System of Units, abbreviated as “SI.”

“Reaction time” refers the time duration during which anodic bias is applied to the water oxidation electrocatalyst, or to a working electrode on which the electrocatalyst is disposed.

“Nanoparticles” refers to a material (e.g., water oxidation electrocatalyst) provided as solid particles with at least one size dimension in the range of 1 nm to 1 μm. Relevant examples of a size dimension include: length, width, diameter, area-based diameter, and volume-based diameter. The nanoparticle volume, area, weight, and area each may be an average property reflective of the nanoparticle size distribution. Interaction among nanoparticles may lead to aggregation of the nanoparticles into larger aggregates, or clusters of nanoparticles. As used herein, the term “nanoparticle” is not intended to include a cluster or aggregate of nanoparticles.

As used herein, the term “degrading,” when referring to the electrocatalysis of a PFAS or other compound of interest refers to the breaking of at least one covalent bond in the PFAS or other compound of interest and, in preferred embodiments, results in breaking the PFAS or other compound of interest into two or more smaller compounds.

As used herein, the “first-row transition metals” are scandium (Sc), titanium (Ti), vanadium (V), chromium (Cr), manganese (Mn), iron (Fe), cobalt (Co), nickel (Ni), copper (Cu), and zinc (Zn). In preferred embodiments, water oxidation electrocatalysts comprising two or more transition metals are predominantly nickel.

### EXAMPLES

### Example 1

This Example describes studies that were performed to demonstrate the formation of fluoride by electrocatalytic oxidation of an exemplar PFAS, PFOA using a [NiFe]-layered double hydroxide nanocatalyst as an exemplar water oxidation electrocatalyst.

Two hundred μg of laser-made [NiFe]-layered double hydroxide nanocatalyst was immnobilized on a 4.9 cm² (geometric area) hydrophilic CFP electrode that served as the working electrode in a standard one-compartment, three-electrode electrochemical glass cell. The electrolyte was 30 mL of deionized water, to which 100 mM KOH and 10 mM PFOA were added. A nickel mesh counter electrode and an Ag/AgCl reference electrode were used. A constant potential of +1.2 V vs. Ag/AgCl was applied, and the solution was rigorously stirred during electrolysis for 60 min. After electrolysis, 5 mL of saturated aqueous CaCI₂ solution was added to the electrolyte, resulting in a white precipitate, which was centrifuged, thoroughly washed five times with de-ionized water and one time with acetone, and dried. We hypothesized that any fluoride that was produced from PFOA would form CaF₂ and precipitate from the aqueous solution; other solids are likely CaCO₃ and Ca(OH)₂ that form in alkaline water in ambient air. We collected analogous data in electrolyte without PFOA. As shown in FIG. 2, elemental analysis by energy-dispersive X-ray spectroscopy of scanning electron microscopy (“SEM-EDX”) showed fluorine was indeed mineralized from the PFOA-containing electrolyte; the PFOA-free control did not show any fluoride in the Ca²⁺ precipitate.

### Example 2

This Example discusses the results reported in Example 1.

The results reported in Example 1 demonstrate that the new electrocatalysis process at moderate applied potential, using a nonprecious, potent water oxidation catalyst for C—F bond activation together with Ca²⁺ precipitation, enables the mineralization of an exemplar PFAS, PFOA, from aqueous solution.

### Example 3

This Example describes studies that were performed to demonstrate the formation of fluoride by electrocatalytic oxidation of an exemplar PFAS, PFOA using a [NiMn]-layered double hydroxide nanocatalyst as an exemplar water oxidation electrocatalyst.

The study reported in Example 1 was repeated, but with a [NiMn]-layered double hydroxide nanocatalyst in place of the water oxidation electrocatalyst used in Example 1. As in Example 1, fluorine was dissociated from PFOA by electrocatalysis using the [NiMn]-layered double hydroxide nanocatalyst, showing that a second exemplar water oxidation catalyst was able to dissociate fluorine from C—F bonds in an exemplar PFAS.

### Example 4

This Example reports the results of studies to determine how low a concentration of water could be used to dissociate fluorines from PFAS in conducting electrocatalysis with a water oxidation electrocatalyst.

A series of studies were conducted to subject an exemplar PFAS, PFOA, to electrocatalysis using an exemplar water oxidation electrocatalyst. The conditions used were as described in Example 1, except that the percentage of water was varied, with acetonitrile (with 100 mM LiClO₄ added) making up the remaining percentage of the solution (other than the KOH and exemplar PFAS). The studies showed that fluorine did not dissociate from the PFAS when the water concentration was 40 vol % or 45 vol %, but did when the water concentration was raised to 50 vol %. Accordingly, it is surmised that fluorine can be dissociated from the PFAS at a water concentration between 46 vol % and 50 vol %. Any particular concentration of water and any particular combination of water and a non-aqueous solvent can be readily tested to determine whether it allows fluorine did not dissociate from a PFAS under electrocatalysis with a water oxidation electrocatalyst by substituting the combination of water and non-aqueous solvent for the electrolyte solution described in Example 1 and running the assay described in that Example.

### Example 5

This Example reports the results of studies of concentrations of PFAS and the use of a different source of ions to allow the predominantly aqueous solution to serve as an electrolyte.

Studies were conducted to determine if the ability of the inventive methods and systems to dissociate fluorines from an exemplar PFAS compound was dependent on the concentration of the PFAS compound in the electrolyte. Accordingly, studies were conducted to test the ability of the inventive systems and methods to dissociate fluorine from an exemplar PFAS by providing the PFAS compound at different concentrations. Example 1, above, reports the results of a study conducted in which 10 mM PFOA was added to the electrolyte. A second study repeated the study of Example 1, but adding 5 mM PFOA, rather than the 10 mM PFOA used in the study reported in Example 1. A third study was conducted using 0.9 mM PFOA, but in which 100 mM of pH 9.2 aqueous borate buffer (another source of ions commonly used in electrocatalysis) was added instead of 100 mM aqueous KOH.

All the studies showed dissociation of fluorine from the PFOA, evidencing the ability of the inventive process to degrade an exemplar PFAS provided to the water oxidation electrocatalyst in concentrations that differed by more than an order of magnitude (0.9 mM compared to 10 mM) and in different electrolytes.

### Example 6

This study reports maintaining the electrical conductivity of the electrolyte when using a predominantly aqueous solution that has ions present allowing it to serve as an electrolyte.

As noted above, water-based electrolytes have not been used for electrocatalysis of PFAS, and in preferred embodiments of the present invention, the percentage of water present will be 50 vol % or more. As persons of skill will appreciate, as the percentage of water in the solution goes up, the percentage of any non-aqueous solvents (such as organic solvents) in the electrolyte will go down. This may require the practitioner to adjust the electric conductivity of the electrolyte. For example, in a study adding 100 mM KOH to the predominantly aqueous solution, 100 mM lithium perchlorate was added to the organic phase. It is assumed persons of skill are well familiar with whether and how to adjust the electroconductivity for any particular combination of aqueous and organic phases in the electrolyte and to verify that the electroconductivity is adequate for both phases.

### Example 7

This Example reports the results of a study to determine whether elevating the temperature of the electrolyte effects the electrocatalysis of an exemplar compound to be degraded.

To analyze the effect elevating the temperature of the electrolyte has on the electrochemical degradation of pollutants, experiments conducted at room temperature (25° C.) were repeated at 60° C. The experiments were run in aqueous solutions containing 0.1 M potassium hydroxide as an exemplar electrolyte and PFOA as an exemplar PFAS substrate. The solutions were heated uniformly until a solution temperature of 60° C. was achieved. In a 50 mL bulk electrolysis cell, a 9 cm² hydrophilic carbon fiber paper with NiFe-LDH catalyst was used as the working electrode and a 9 cm² hydrophilic carbon fiber paper was used as the counter electrode. A platinum wire pseudo-reference electrode was used, which was calibrated prior to the experiment using the ferrocyanide-ferricyanide redox couple. Once the target temperature was achieved, the electrolysis was run for one, two, or three hours at 1.6 V_{RHE} under continuous ultra-violet radiation (254 nm). After electrolysis, the fluoride concentration in each electrolyte was analyzed using an ion selective electrode. The comparative results are shown in FIG. 4. FIG. 4 shows that, at each time point, more fluorine ion was produced at the higher temperature compared to the amount produced at room temperature.

### Example 8

This Example reports the results of a study of the electrocatalytic degradation of a second exemplar PFAS, perfluorooctanesulfonic acid, or “PFOS.”

To analyze the versatility of our electrocatalytic degradation process, we replaced PFOA with perfluorooctanesulfonic acid (PFOS) as the exemplar pollutant. The experiments were run in aqueous solutions containing 0.1 M potassium hydroxide as the electrolyte and PFOS as the substrate. In a 50 mL bulk electrolysis cell, a 9 cm² hydrophilic carbon fiber paper with NiFe-LDH catalyst was used as the working electrode and a 9 cm² hydrophilic carbon fiber paper was used as the counter electrode. A platinum wire pseudo-reference electrode was used, which was calibrated prior to the experiment using the ferrocyanide-ferricyanide redox couple. The electrolysis was run for one, two, or three hours at 1.6 V_{RHE} under continuous ultra-violet radiation (254 nm). After electrolysis the fluoride concentration in each electrolyte was analyzed using an ion selective electrode.

The results are shown in FIG. 5. As can be seen in FIG. 5, the PFOS not only underwent degradation in the electrocatalytic process, but was degraded at a rate approximately an order of magnitude faster than the rate at which the first exemplar PFAS was degraded under the same conditions. Thus, the rate of degradation can vary depending on the particular PFAS or other compound to be degraded.

### Example 9

This Example reports the results of a study to determine whether running electrocatalysis under a negative (cathodic) bias would result in degradation of an exemplar compound.

The study was run in aqueous solutions containing 0.1 M potassium hydroxide as the electrolyte and an exemplar PFAS, PFOA, as the test substrate to be degraded. In a 50 mL bulk electrolysis cell, a 9 cm² hydrophilic carbon fiber paper with NiFe-LDH catalyst was used as the working electrode and a 9 cm² hydrophilic carbon fiber paper was used as the counter electrode. A platinum wire pseudo-reference electrode was used, which was calibrated prior to the experiment using the ferrocyanide-ferricyanide redox couple. The electrolysis was run for one, two, or three hours at −1.6 V_{RHE} under continuous ultra-violet radiation (254 nm). After electrolysis the fluoride concentration in each electrolyte was analyzed using an ion selective electrode, and compared to results of subjecting the same test substrate to degradation using an anodic bias of 1.6 V_{RHE}.

The results are shown in FIG. 6. As can be seen in FIG. 6, electrocatalysis of the substrate PFOA using a cathodic bias (negative applied electric potential), produced modestly less F⁻ at each time point than did electrocatalysis of the same substrate using an anodic bias. Electrocatalysis using either a cathodic bias or an anodic bias, however, resulted in degradation within the same order of magnitude, indicating that either can be used to degrade a compound, such as a PFAS compound, whose degradation is desired.

### Example 10

This Example reports the results of a study to determine if electrode supports of hydrophilic carbon fiber paper (“CFP”) are necessary to support the electrocatalyst, or whether or materials can be used.

A study was conducted comparing the degradation of an exemplar PFAS compound, PFOA, using an exemplar metal catalyst, NiFe-layered double hydroxide (“LDH”) on (1) a CFP support or (2) a nickel mesh support. The results are presented in Table 1, below, and FIG. 7.

TABLE 1
Comparison of electrocatalysis using a metal catalyst
on a hydrophilic CFP support versus the same
metal catalyst on a nickel mesh support

| Working Electrode | F- concentration |
|---|---|
| NiFe-LDH on hydrophilic CFP | 0.568 |
| NiFe-LDH on Ni mesh | 0.464 |

As can be seen, both from the results presented in Table 1 and as shown graphically in FIG. 7, more fluorine ions were released from the PFAS when the NiFe electrocatalyst was disposed on hydrophilic CFP as the working electrode than when the same electrocatalyst was disposed on a nickel mesh. The difference in the results of the two reactions is, however, modest, and both are in the same order of magnitude, showing that materials other than hydrophilic CFP can be used as a solid support supporting the electrocatalyst in different embodiments.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A system for degrading a per- or polyfluoroalkyl substance (“PFAS”) atom, said system comprising:
(a) a first container,
(b) an electrolyte solution disposed in said first container, which electrolyte solution is 46 vol % or more water and which has a ion concentration allowing ionic conductivity through said electrolyte solution, thereby allowing said electrolyte to serve as an electrolyte,
(c) a “PFAS”, said PFAS dissolved in said electrolyte solution,
(d) a working electrode at least partially immersed in said electrolyte solution,
(e) a water oxidation electrocatalyst immobilized on said working electrode and in contact with (1) said PFAS dissolved in said electrolyte solution, and (2) said electrolyte solution,
(f) a counter electrode at least partially immersed in said electrolyte solution and electrically connected to said working electrode, and,
(g) a source of electricity electrically connected to said system to provide an applied electric potential to said working electrode,
wherein, when said water containing said one or more compounds is added to said electrolyte solution and an applied electric potential is applied to said working electrode, said applied electric potential causes said at least one covalent bond between a carbon atom and a fluorine atom in said PFAS to be broken, thereby degrading said PFAS.

2-13. (canceled)

14. The system of claim 1, wherein said working electrode is carbon fiber paper.

15. (canceled)

16. The system of claim 1, wherein said water oxidation electrocatalyst is a nanostructured layered double hydroxide solid, nanostructured layered oxide solid, nanostructured layered oxy (hydroxide) solid, a perovskite, a polyoxometalate, or a metal-organic framework.

17-20. (canceled)

21. The system of claim 16, wherein said nanostructured layered double hydroxide, oxide, or oxy (hydroxide) solid comprises nickel mixed with an effective amount of a transition metal, a post-transition metal, or both a transition metal and a post-transition metal.

22. (canceled)

23. (canceled)

24. The system of claim 21, wherein said nanostructured layered double hydroxide, oxide, or oxy (hydroxide) solid is in the form of nanoparticles disposed on said working electrode.

25. The system of claim 21, wherein said water oxidation electrocatalyst is [NiMn]-layered double hydroxide, oxide, or oxy (hydroxide).

26. (canceled)

27. The system of claim 21, wherein said water oxidation electrocatalyst is [NiFe]-layered double hydroxide, oxide, or oxy (hydroxide).

28. (canceled)

29. The system of claim 1, further comprising a source of ultraviolet light, which source of ultraviolet light is positioned to shine on said water oxidation electrocatalyst.

30-50. (canceled)

51. The system of claim 1, said system further comprising a heater to heat said electrolyte solution above room temperature.

52. The system of claim 1, said system further comprising a source introducing air or oxygen into said electrolyte solution.

53. (canceled)

54. (canceled)

55. (canceled)

56. (canceled)

57. A method for degrading a per- or polyfluoroalkyl substance (“PFAS”), said method comprising subjecting said PFAS to electrocatalysis on a water oxidation electrocatalyst, said water oxidation electrocatalyst being disposed on a working electrode, said electrode being disposed in an electrolyte solution comprising 46 vol % or more of water and having an ion concentration allowing ionic conductivity, by providing an applied electric potential of −5 V to 5 V versus standard hydrogen electrode (“SHE”) to said working electrode, thereby breaking said at least one carbon-fluorine bond in said PFAS, thereby degrading said PFAS, provided said applied electric potential is not an open circuit potential.

58-64. (canceled)

65. The method of claim 57, wherein said working electrode is hydrophilic carbon fiber paper.

66. The method of claim 57, wherein said water oxidation electrocatalyst is a metal oxide solid, metal hydroxide solid, or metal oxy (hydroxide).

67. (canceled)

68. The method of claim 57, wherein said water oxidation electrocatalyst is a nanostructured layered double hydroxide solid, nanostructured layered oxide solid, or nanostructured layered oxy (hydroxide) solid, in which one of the layers comprises an effective amount of a transition metal, a post-transition metal, or both a transition metal and a post-transition metal.

69-71. (canceled)

72. The method of claim 68, wherein said nanostructured layered double hydroxide solid, said nanostructured layered oxide solid, or said nanostructured layered oxy (hydroxide) solid, comprises nickel mixed with an effective amount of a transition metal, a post-transition metal, or both a transition metal and a post-transition metal.

73. (canceled)

74. The method of claim 72, wherein said water oxidation electrocatalyst is [NiFe]-layered double hydroxide, [NiFe]-nanostructured layered oxide solid, or [NiFe]-nanostructured layered oxy (hydroxide) solid.

75. (canceled)

76. The method of claim 72, wherein said water oxidation electrocatalyst is [NiMn]-layered double hydroxide, [NiMn]-nanostructured layered oxide solid, or [NiMn]-nanostructured layered oxy (hydroxide) solid.

77-86. (canceled)

87. The method of claim 57, wherein said electrolyte solution is at a temperature above room temperature.

88-90. (canceled)

91. The method of claim 57, further comprising shining ultraviolet light on said water oxidation electrocatalyst.

92-106. (canceled)

107. The method of claim 57, further comprising mineralizing fluorine atoms dissociated from said PFAS by said electrocatalysis, said method comprising adding to said electrolyte cations that form water-insoluble fluorides, thereby mineralizing said fluorine atoms dissociated from said PFAS.

108-114. (canceled)
